(19) United States
(12) Patent Application Publication
(10) Pub. No.: US 2005/0171253 A1
(43) Pub. Date: Aug. 4, 2005

(54) Containers or films comprising hydroxyphenlbenzotriazole uv absorbers for protecting contents against the effects of uv radiation

(76) Inventors: Stephen Mark Andrews, New Fairfield, CT (US); Joseph Suhadolnik, Yorktown Heights, NY (US); Mervin Gale Wood, Mobile, AL (US); Ramanathan Ravichandran, Suffern, NY (US); Dirk Simon, Mutterstadt (DE)

Correspondence Address: CIBA SPECIALTY CHEMICALS CORPORATION;PATENT DEPARTMENT, 540 WHITE PLAINS RD, P O BOX 2005, TARRYTOWN, NY, 10591-9005, US

(21) Appl. No.: 10/504,278

(22) PCT Filed: Feb. 11, 2003
(86) PCT No.: PCT/EP03/01324

Related U.S. Application Data
(60) Provisional application No. 60/357,942, filed on Feb. 19, 2002.

(51) Int. Cl. C08K 5/34

(52) U.S. Cl. 524/106

(57) ABSTRACT

The contents of clear or lightly colored plastic containers or films are protected from ultraviolet radiation by the incorporation of certain UV absorbers of the class of reactable, durable hydroxyphenylbenzotriazoles in the container or film. The hydroxyphenylbenzotriazoles are reacted into the containers or films via condensation reaction and are thereby covalently bonded therein. Contents to be protected include foodstuffs, beverages, pharmaceuticals, cosmetics, personal care products, shampoos and the like.

The present invention relates to the protection of foodstuffs, beverages, pharmaceuticals, cosmetics, personal care products, shampoos and the like from the deleterious effects of ultraviolet radiation. It has been found that certain durable, reactable 2H-benzotriazole ultraviolet light absorbers are especially effective towards this end when incorporated into the containers or films in which such materials are stored.

Many products such as certain fruit juices, soft drinks, beer, wines, food products, dairy products, cosmetics, shampoos, vitamins and pharmaceuticals are deleteriously affected, i.e. degraded, by the effects of ultraviolet (UV) light when packaged in plastic containers which allow the transmission of such light.

The use of UV absorbers (UVA's) towards protecting bottle and film contents is well known. However there is a trend towards the use of clear or lightly colored containers. More aesthetically pleasing containers may be formed from clear plastics which also allow one to view the contents. Unfortunately, clear and lightly colored containers and films allow the transmission of significant portions of ultraviolet light, i.e. light in the range of about 280 to about 400 nm. Further, there is a trend towards more light-weight and hence thinner walled containers. Thin-walled containers, by virtue of a shorter path length, will allow more UV light to pass. Due to these trends in packaging there is a need for more efficient UV absorbers for use in this area. UV absorber efficiency is a function of how strongly the molecule absorbs light across the entire UV region as well as its thermal and photostability, i.e. durability.

Many cooking oils and salad oils are now offered in clear PET [poly(ethylene terephthalate)] packaging. Practically all vegetable or seed-based oils such as soybean, olive, safflower, cottonseed and corn oils contain varying levels of unsaturated olefinic acids or esters (e.g. linoleates) which are susceptible to light-induced degradation. Most plant based oils also contain natural chlorophyll or other pigment photosensitizers. Pascall, et al., J. Food Sci., 60 (5), 1116 (1995), discuss the UV protection of soybean oil with the use of Tinuvin® 326 incorporated into coextruded, multi-layered, polypropylene-based containers. Tinuvine® 326 is a 2H-benzotriazole UV absorber, 5-chloro-2-(2-hydroxy-3-tert-butyl-5-methylphenyl)-2H-benzotriazole, available from Ciba Specialty Chemicals Corp.

Milk is packaged in translucent or white pigmented HDPE bottles to reduce the amount of light transmission through the plastic. Fanelli, et al., J. Food Protection, 48(2), 112-117 (1985) disclose that Tinuvine® 326 in HDPE packaging is effective at reducing the loss rate of Vitamin A in milk exposed to cool white fluorescent light. Protection of vitamins is also of importance in fruit juices. In “Tropicana Twists Again,” Packaging World, January 1999, p. 2, it is disclosed that PET bottles containing a “UV inhibitor” are used to protect the shelf life of Vitamin C in fruit drinks.

The use of Tinuvino® 234, 2-(2-hydroxy-3,5-di-α-cumyl)-2H-benzotriazole, Tinuvin® 326, 5-chloro-2-(2-hydroxy-3-tert-butyl-5-methylphenyl)-2H-benzotriazole, Tinuvin® 327, 5-chloro-2-(2-hydroxy-3,5-di-tert-butylphenyl)-2H-benzotriazole, and Tinuvin® 1577, 4,6-diphenyl-2-(4-hexyloxy-2-hydroxyphenyl)-s-triazine, in packaging for content protection is known. In particular, the combinations of Tinuvin® 234 with either Tinuvin® 327 or Tinuvin® 326 are known.

It is well known that beer is normally bottled in amber or green-tinted glass to protect it from light. A highly efficient UV absorber would allow beer to be packaged in, for example, clear PET bottles.

U.S. Pat. Nos. 4,882,412, 4,892,923 and 4,950,732 disclose the use of 7-oxy-2H-1-benzopypran-2-one, 7-oxy-2H-1-benzopyran-2-imine, 3H-naphtho[2,1-b]pyran-3-one, 3H-naphtho[2,1-b]pyran-3-imine and bis-methine moieties as UV absorbing groups to protect the contents of polyester and polycarbonate containers.

U.S. Pat. No. 5,948,458 teaches the protection of foods containing unsaturated lipids and fats from spoilage due to exposure to UV radiation by incorporation of calcium phosphate compounds either directly into the food product itself or in the food coatings and package wrap.

It has been found that certain durable, reactable 2H-benzotriazole absorbers are especially effective towards protecting the contents of clear, lightly colored and thin-walled containers and films.

The description, preparation and uses of 2H-benzotriazole UV absorbers are described in U.S. Pat. Nos. 3,004,896; 3,055,896; 3,072,585; 3,074,910; 3,189,615; 3,230,194; 4,127,586; 4,226,763; 4,278,589; 4,315,848; 4,383,863; 4,675,352; 4,681,905 and 4,853,471.

U.S. Pat. Nos. 5,319,091 and 5,410,071 described the preparation of 2H-benzotriazoles substituted at the 5-position of the benzo ring with alkyl- or aryl-sulfonyl moieties. It is taught in U.S. Pat. No. 5,280,124 that by introducing a higher alkyl or aryl sulfoxide or sulfone at the 5-position of the benzo ring of the benzotriazole, the resulting benzotriazole exhibits enhanced absorption in the near visible range (over 350 nm). Such sulfone substituted products were shown to be useful in automotive coatings applications. U.S. Pat. Nos. 5,977,219 and 6,166,218 teach that an electron withdrawing moiety at the 5-position of the benzo ring of the benzotriazole is advantageous for similar reasons. Additionally, these patents teach that such an electron withdrawing group dramatically increases the photostability of benzotriazole UV absorbers in automotive coatings. U.S. Pat. No. 5,574,166 teaches that benzotriazoles with a cumyl group ortho to the phenol are especially thermally stable. Reactable forms of such durable 2H-benzotriazoles are found to be especially well-suited for the instant applications.

U.S. Pat. No. 5,278,314 discloses 5-thio substituted 2H-benzotriazoles.

U.S. Pat. No. 3,218,332 discloses 2H-benzotriazoles substituted at the 5-position of the benzo ring by a lower alkyl sulfonyl moiety. U.S. Pat. Nos. 5,268,450 and 5,319,091 disclose polymer compositions and a process for the production of substituted aryl thio and aryl sulfonyl benzotriazoles which are covalently bonded to polymers, such as poly(phenylene sulfide), RYTON®, Phillips Petroleum. U.S. Pat. No. 5,280,124 discloses benzotriazoles with only higher alkyl or aryl sulfinyl or sulfonyl moieties at the 5-position of the benzo ring which are useful for protecting thermoset automotive coatings. U.S. Pat. Nos. 5,977,219 and 6,166,218 mentioned above teach the use of certain electron withdrawing groups including some sulfonyl groups at the 5-position of the benzo ring for the stabilization of automotive coatings.

U.S. Pat. No. 6,187,845 teaches the use of a class of UV absorbers in adhesive compositions suitable for use as an adhesive layer in a laminated article or multi-layer construction. The laminated articles include solar control films, films and glazings, UV absorbing glasses and glass coatings, optical films and the like. The protection of interior structures, textiles and fabrics from UV induced photodegradation such as in automotive applications is discussed.

Japanese Patent No. 92-352228 discloses the use of 5-ethylsulfonyl benzotriazoles with the 3-position of the phenyl ring being unsubstituted or substituted by methyl for the UV protection of dust proof poly(vinyl chloride) resin films.

Japanese Patent No. 96120065 discloses certain hydroxyphenylbenzotriazole UV absorbers in polyester.

Japanese Patent Nos. 95145246 and 95145247 disclose the reaction of certain hydroxy-phenylbenzotriazoles into resins.

Japanese Patent No. 9-316313 teaches end-capping of polycarbonate with certain benzotriazole UV absorbers.

U.S. Pat. No. 6,037,393 teaches polyester-containing benzotriazole compounds.

U.S. Pat. No. 6,218,450 discloses polyester compositions with various UV absorbers.

EP 464522 discloses the reaction of certain benzotriazole UV absorbers into PET elastomer.

It is known in the art that the concomitant use of a hindered amine light stabilizer with UV absorbers such as 2H-benzotriazoles and s-triazines provide excellent stabilization in many polymer compositions as summarized by G. Berner and M. Rembold, “New Light Stabilizers for High Solids Coatings”, Organic Coatings and Science and Technology, Vol. 6, Dekkar, New York, pp 55-85.

The instant invention pertains to a method of protecting contents against the deleterious effects of ultraviolet radiation,
which method comprises storing the contents in a clear or lightly colored plastic container or film,
which container or film comprises
(a) a polymer component able to undergo a condensation reaction and
(b) an effective stabilizing amount of one or more UV absorbing moieties,
wherein said moieties are permanently and covalently bonded to the polymer component and are derived, via condensation, from UV absorbers selected from the group consisting of the durable hydroxyphenylbenzotriazole UV absorbers.

Where the plastic of component (a) is lightly colored it is colored with pigments and/or dyes. Plastic containers and films made therefrom transmit significant portions of radiation of the ultraviolet region, i.e. about 280 to about 400 nm. Ultraviolet absorbers (UVA's) that are red-shifted absorb radiation towards the 400 nm region of the spectrum more efficiently than UVA's that are not red-shifted. Many of the present reactable benzotriazloes, in addition to being highly durable, are also red-shifted.

The clear or lightly colored plastic of component (a) contains an upper limit of about 5% pigments and/or dyes by weight, in total, based on the weight of the plastic. For instance, the plastic of component (a) contains an upper limit of about 2% by weight pigments and/or dyes based on the weight of the plastic. The upper limit of pigments and/or dyes in the plastic may be for example about 1% by weight.

The UV absorbers of component (b) exhibit excellent compatibility with the plastic containers or films of this invention. Further, they add little or no color to finished plastic containers or films.

For instance the hydroxyphenylbenzotriazole UV absorbers are of formula (I), (II) or (III) 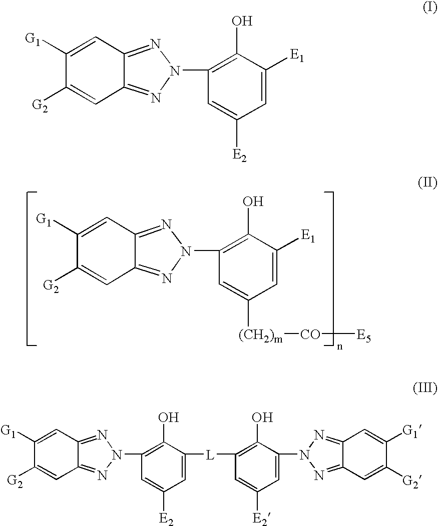
wherein
G₁ and G₁′ are independently hydrogen or halogen,
G₂ and G₂′ are independently halogen, nitro, cyano, perfluoroalkyl of 1 to 12 carbon atoms, —COOG₃, —P(O)(C₆H₅)₂, —CO-G₃, —CO—NH-G₃, —CO—N(G₃)₂, —N(G₃)-CO-G₃, E₃S—, E₃SO— or E₃SO₂—; or one of G₂ and G₂′ is also hydrogen,
G₃ is hydrogen, straight or branched chain alkyl of 1 to 24 carbon atoms, straight or branched chain alkenyl of 2 to 18 carbon atoms, cycloalkyl of 5 to 12 carbon atoms, phenylalkyl of 7 to 15 carbon atoms, phenyl, or said phenyl or said phenylalkyl substituted on the phenyl ring by 1 to 4 alkyl of 1 to 4 carbon atoms,
E₁ is hydrogen, straight or branched chain alkyl of 1 to 24 carbon atoms, straight or branched chain alkenyl of 2 to 24 carbon atoms, cycloalkyl of 5 to 12 carbon atoms, phenylalkyl of 7 to 15 carbon atoms, phenyl, or said phenyl or said phenylalkyl substituted on the phenyl ring by 1 to 4 alkyl of 1 to 4 carbon atoms; or E₁ is alkyl of 1 to 24 carbon atoms substituted by one or two hydroxy groups,
when E₁ is phenylalkyl of 7 to 15 carbon atoms or phenyl, or said phenyl or said phenylalkyl substituted on the phenyl ring by 1 to 4 alkyl of 1 to 4 carbon atoms, G₂ may also be hydrogen,
E₂ is straight or branched chain alkyl of 1 to 24 carbon atoms or straight or branched chain alkenyl of 2 to 18 carbon atoms, each substituted by one or more —OH, —OCOE₁, —NCO, —NH₂, —NHCOE₁₁, —NHE₄ or glycidyloxy groups, or by mixtures thereof; or said alkyl or said alkenyl interrupted by one or more —O—, —NH— or —NE₄- groups or by mixtures thereof, where E₄ is straight or branched chain alkyl of 1 to 24 carbon atoms,
E₂′ is straight or branched alkyl chain of 1 to 24 carbon atoms, straight or branched chain alkenyl of 2 to 18 carbon atoms, cycloalkyl of 5 to 12 carbon atoms, phenylalkyl of 7 to 15 carbon atoms, phenyl, or said phenyl or said phenylalkyl substituted on the phenyl ring by one to three alkyl of 1 to 4 carbon atoms; or
E₂′ is said alkyl of 1 to 24 carbon atoms or said alkenyl of 2 to 18 carbon atoms substituted by one or more —OH, —OCOE₁₁, —OE₄, —NCO, —NH₂, —NHCOE₁₁, —NHE₄, —N(E₄)₂ or glycidyloxy groups, or by mixtures thereof, where E₄ is straight or branched chain alkyl of 1 to 24 carbon atoms; or said alkyl or said alkenyl interrupted by one or more —O—, —NH— or —NE₄-groups or by mixtures thereof and which can be unsubstituted or substituted by one or more —OH, —OE₄ or —NH₂ groups or mixtures thereof,
n is 1 or 2,
when n is 1,
E₅ is OE₆ or NE₇E₈, or E₅ is —PO(OE₁₂)₂, —OSi(E₁₁)₃ or —OCO-E₁₁, or straight or branched chain C₁-C₂₄alkyl which is interrupted by —O—, —S— or —NE₁₁ and which can be unsubstituted or substituted by —OH or —OCO-E₁₁, C₅-C₁₂ cycloalkyl which is unsubstituted or substituted by —OH, straight chain or branched C₂-C₁₈alkenyl which is unsubstituted or substituted by —OH, C₇-C₁₅aralkyl, —CH₂—CHOH-E₁₃ or glycidyl,
E₆ is hydrogen, straight or branched chain C₁-C₂₄alkyl which is unsubstituted or substituted by one or more OH, OE₄ or NH₂ groups, or —OE₆ is —(OCH₂CH₂)_{w}OH or —(OCH₂CH₂)_{w}OE₂₁where w is 1 to 12 and E₂₁ is alkyl of 1 to 12 carbon atoms,
E₇ and E₈ are independently hydrogen, alkyl of 1 to 18 carbon atoms, straight or branched chain C₃-C₁₈alkyl which is interrupted by —O—, —S— or —NE₁₁-, C₅-C₁₂cycloalkyl, C₆-C₁₄aryl or C₁-C₃hydroxylalkyl, or E₇ and E₈ together with the N atom are a pyrrolidine, piperidine, piperazine or morpholine ring,
E₅ is —X-(Z)_{p-Y-E}₁₅ wherein
X is —O— or —N(E₁₆)-,
Y is —O— or —N(E₁₇)-,
Z is C₂-C₁₂-alkylene, C₄-C₁₂-alkylene interrupted by one to three nitrogen atoms, oxygen atoms or a mixture thereof, or is C₃-C₁₂-alkylene, butenylene, butynylene, cyclohexylene or phenylene, each substituted by a hydroxyl group,
m is zero, 1 or 2,
p is 1, or p is also zero when X and Y are —N(E₁₆)- and —N(E₁₇)-, respectively,
E₁₅ is a group —CO—C(E₁₈)=C(H)E₁₉ or, when Y is —N(E₁₇)-, forms together with E₁₇ a group —CO—CH═CH—CO—, wherein E₁₈ is hydrogen or methyl, and E₁₉ is hydrogen, methyl or —CO—X-E₂₀, wherein E₂₀ is hydrogen, C₁-C₁₂-alkyl or a group of the formula 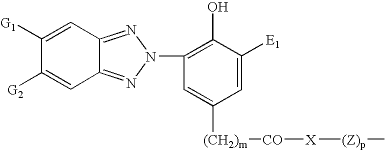
   wherein the symbols E₁, G₂, X, Z, m and p have the meanings defined above, and E₁₆ and E₁₇ independently of one another are hydrogen, C₁-C₁₂-alkyl, C₃-C₁₂-alkyl interrupted by 1 to 3 oxygen atoms, or is cyclohexyl or C₇-C₁₅aralkyl, and E₁₆ together with E₁₇ in the case where Z is ethylene, also forms ethylene,
when n is 2, one of G₂ is also hydrogen,
E₅ is one of divalent radicals —O-E₉-O— or —N(E₁₁)-E₁₀-N(E₁₁)-,
E₉ is C₂-C₈alkylene, C₄-C₈alkenylene, C₄alkynylene, cyclohexylene, straight or branched chain C₄-C₁₀alkylene which is interrupted by —O— or by —CH₂—CHOH—CH₂—O-E₁₄-O—CH₂—CHOH—CH₂—,
E₁₀ being straight or branched chain C₂-C₁₂alkylene which may be interrupted by —O—, cyclohexylene, or 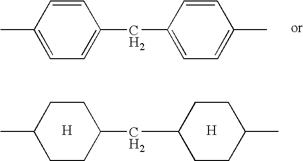
or E₁₀ and E₁₁ with the two nitrogen atoms form a piperazine ring,
E₁₄ is straight or branched chain C₂-C₈alkylene, straight or branched chain C₄-C₁₀alkylene which is interrupted by —O—, cycloalkylene, arylene or 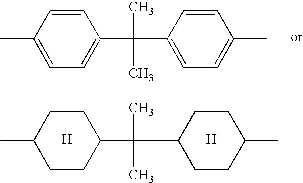
   where E₇ and E₈ are independently hydrogen, alkyl of 1 to 18 carbon atoms or E₇ and E₈ together are alkylene of 4 to 6 carbon atoms, 3-oxapentamethylene, 3-iminopentamethylene or 3-methyliminopentamethylene,
E₁₁ is hydrogen, straight or branched chain C₁-C₁₈alkyl, C₅-C₁₂cycloalkyl, straight or branched chain C₂-C₁₈alkenyl, C₆-C₁₄aryl or C₇-C₁₅aralkyl,
E₁₂ is straight or branched chain C₁-C₁₈alkyl, straight or branched chain C₃-C₈alkenyl, C₅-C₁₀cycloalkyl, C₆-C₁₆aryl or C₇-C₁₅aralkyl,
E₁₃ is H, straight chain or branched C₁-C₁₈alkyl which Is substituted by —PO(OE₁₂)₂, phenyl which is unsubstituted or substituted by OH, C₇-C₁₅saralkyl or —CH₂OE₁₂,
E₃ is alkyl of 1 to 20 carbon atoms, hydroxyalkyl of 2 to 20 carbon atoms, alkyl substituted by alkoxycarbonyl of 2 to 9 carbon atoms, alkenyl of 3 to 18 carbon atoms, cycloalkyl of 5 to 12 carbon atoms, phenylalkyl of 7 to 15 carbon atoms, aryl of 6 to 10 carbon atoms or said aryl substituted by one or two alkyl of 1 to 4 carbon atoms or 1,1,2,2-tetrahydroperfluoroalkyl where the perfluoroalkyl moiety is of 6 to 16 carbon atoms, and
L is alkylene of 1 to 12 carbon atoms, alkylidene of 2 to 12 carbon atoms, benzylidene, p-xylylene, α,α,α′,α′-tetramethyl-m-xylylene or cycloalkylidene.

For instance said hydroxyphenylbenzotriazole UV absorbers are of the formula 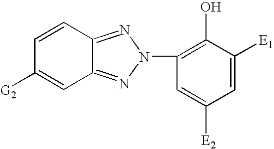
where G₂ is selected from Cl, F, —SO₂Ph, —SO₂Butyl and —CF₃; E₁ is t-butyl or α-cumyl and E₂ is selected from —CH₂CH₂OH, —CH₂CH₂CO₂H, —CO²C₁-C₆alkyl and —CO₂(polyethylene glycol),
or the hydroxyphenylbenzotriazole UV absorbers are of the formula 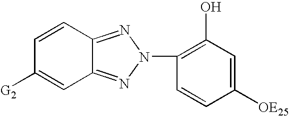
where
G₂ is selected from hydrogen, halogen, nitro, cyano, perfluoroalkyl of 1 to 12 carbon atoms, —COOG₃, —P(O)(C₆H₅)₂, —CO-G₃, —CO—NH-G₃, —CO—N(G₃)₂, —N(G₃)—CO-G₃, E₃S—, E₃SO— or E₃SO₂—; and

E₂₅ is straight or branched chain alkyl of 1 to 24 carbon atoms or straight or branched chain alkenyl of 2 to 18 carbon atoms, each substituted by one or more —OH, —OCOE₁₁, —NCO,

—NH₂, —NHCOE₁₁, —NHE₄ or glycidyloxy groups, or by mixtures thereof; or said alkyl or said alkenyl interrupted by one or more —O—, —NH— or —NE₄- groups or by mixtures thereof, where E₄ is straight or branched chain alkyl of 1 to 24 carbon atoms,

or the hydroxyphenylbenzotriazole UV absorbers are 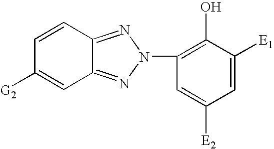
where E₁ is t-butyl or α-cumyl, E₂ is straight or branched chain alkyl of 1 to 8 carbon atoms and G₂ is CH₃OCOCH₂S— or CH₃OCOCH₂SO₂—.

Typically the hydroxyphenylbenzotriazole UV absorbers are of formula (I) 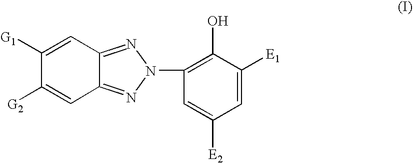
wherein
G₁ is hydrogen,
G₂ is hydrogen, cyano, chloro, fluoro, —CF₃, —COG₃, E₃SO— or E₃SO₂—,
G₃ is straight or branched chain alkyl of 1 to 24 carbon atoms, straight or branched chain alkenyl of 2 to 18 carbon atoms, cycloalkyl of 5 to 12 carbon atoms, phenylalkyl of 7 to 15 carbon atoms, phenyl, or said phenyl or said phenylalkyl substituted on the phenyl ring by 1 to 4 alkyl of 1 to 4 carbon atoms,
E₁ is phenylalkyl of 7 to 15 carbon atoms, phenyl, or said phenyl or said phenylalkyl substituted on the phenyl ring by 1 to 4 alkyl of 1 to 4 carbon atoms,
E₂ is straight or branched alkyl of 1 to 24 carbon atoms or straight or branched chain alkenyl of 2 to 18 carbon atoms, each substituted by one or more —OH, —OCOE₁₁, —NCO, —NH₂,
   —NHCOE₁₁, —NHE₄ or glycidyloxy groups, or by mixtures thereof, where E₄ is straight or branched chain alkyl of 1 to 24 carbon atoms; or said alkyl or said alkenyl interrupted by one or more —O—, —NH— or —NE₄- groups or by mixtures thereof, and
E₃ is alkyl of 1 to 20 carbon atoms, hydroxyalkyl of 2 to 20 carbon atoms, alkenyl of 3 to 18 carbon atoms, cycloalkyl of 5 to 12 carbon atoms, phenylalkyl of 7 to 15 carbon atoms, aryl of 6 to 10 carbon atoms or said aryl substituted by one or two alkyl of 1 to 4 carbon atoms or 1,1,2,2-tetrahydroperfluoroalkyl where the perfluoroalkyl moiety is of 6 to 16 carbon atoms,
or is a compound of formula (I)
   wherein
G₁ is hydrogen,
G₂ is chloro, fluoro, —CF₃, E₃SO— or E₃SO₂—,
E₁ is hydrogen or straight or branched alkyl of 1 to 24 carbon atoms,
E₂ is straight or branched alkyl of 1 to 24 carbon atoms or straight or branched chain alkenyl of 2 to 18 carbon atoms, each substituted by one or more —OH, —OCOE₁₁, —NCO, —NH₂,
   —NHCOE₁₁, —NHE₄ or glycidyloxy groups, or by mixtures thereof, where E₄ is straight or branched chain alkyl of 1 to 24 carbon atoms; or said alkyl or said alkenyl interrupted by one or more —O—, —NH— or —NE₄- groups or by mixtures thereof, and
E₃ is straight or branched chain alkyl of 1 to 7 carbon atoms.

For instance the hydroxyphenylbenzotriazole UV absorbers of formula (II) are of formula (IIA) 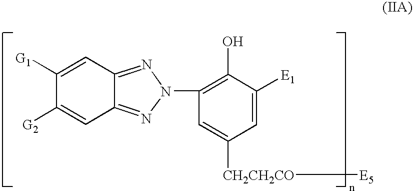
wherein
G₁ is hydrogen,
G₂ is —CF₃ or fluoro,
E₁ is hydrogen, straight or branched alkyl of 1 to 24 carbon atoms or phenylalkyl of 7 to 15 carbon atoms,
when E₁ is phenylalkyl of 7 to 15 carbon atoms, G₂ may also be hydrogen,
E₅ is —OE₆ or —NE₇E₈, or
E₅ is —X-(Z)ₚ-Y-E₁₅
   wherein
X is —O— or —N(E₁₆)-,
Y is —O— or —N(E₁₇)-,
Z is C₂-C₁₂-alkylene, C₄-C₂-alkylene interrupted by one to three nitrogen atoms, oxygen atoms or a mixture thereof, or is C₃-C₁₂-alkylene, butenylene, butynylene, cyclohexylene or phenylene, each substituted by a hydroxyl group,
m is 0, 1, 2 or 3,
p is 1, or p is also zero when X and Y are —N(E₁₆)- and —N(E₁₇)-, respectively,
E₁₅ is a group —CO—C(E₁₈)=C(H)E₁₉ or, when Y is —N(E₁₇)-, forms together with E₁₇ a group —CO—CH═CH—CO—, wherein E₁₈ is hydrogen or methyl, and E₁₉ is hydrogen, methyl or —CO—X-E₂₀, wherein E₂₀ is hydrogen, C₁-C₁₂-alkyl or a group of the formula

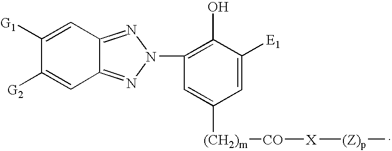

For example the hydroxyphenylbenzotriazole UV absorbers of formula (III) are of the formula (IIIA) 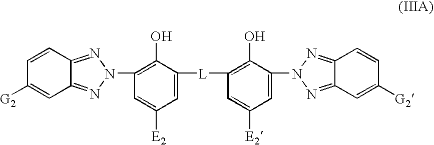
wherein
G₂ and G₂′ are independently hydrogen or —CF₃, where at least one of G₂ and G₂′ is —CF₃,
E₂ is straight or branched chain alkyl of 1 to 24 carbon atoms or straight or branched chain alkenyl of 2 to 18 carbon atoms, each substituted by one or more —OH, —OCOE₁₁, —NCO,
   —NH₂, —NHCOE₁, —NHE₄ or glycidyloxy groups, or by mixtures thereof; or said alkyl or said alkenyl interrupted by one or more —O—, —NH— or —NE₄- groups or by mixtures thereof, where E₄ is straight or branched chain alkyl of 1 to 24 carbon atoms,
E₂′ is straight or branched alkyl chain of 1 to 24 carbon atoms, straight or branched chain alkenyl of 2 to 18 carbon atoms, cycloalkyl of 5 to 12 carbon atoms, phenylalkyl of 7 to 15 carbon atoms, phenyl, or said phenyl or said phenylalkyl substituted on the phenyl ring by 1 to 3 alkyl of 1 to 4 carbon atoms; or
E₂′ is straight or branched chain alkyl of 1 to 24 carbon atoms or straight or branched chain alkenyl of 2 to 18 carbon atoms substituted by one or more —OH, —OCOE₁₁, —NCO, —NH₂,
   —NHCOE₁₁, —NHE₄ or glycidyloxy groups, or by mixtures thereof; or said alkyl or said alkenyl interrupted by one or more —O—, —NH— or —NE₄- groups or by mixtures thereof, where E₄ is straight or branched chain alkyl of 1 to 24 carbon atoms; and
L is alkylene of 1 to 12 carbon atoms, alkylidene of 2 to 12 carbon atoms, benzylidene, p-xylylene, α,α,α′,α′-tetramethyl-m-xylylene or cycloalkylidene.

In a specific embodiment of the invention the hydroxyphenylbenzotriazole UV absorbers are of formula (I) 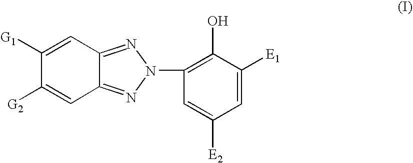
wherein
G₁ is hydrogen,
G₂ is —CF₃,
E₁ is phenylalkyl of 7 to 15 carbon atoms, phenyl, or said phenyl or said phenylalkyl substituted on the phenyl ring by 1 to 4 alkyl of 1 to 4 carbon atoms,
E₂ is straight or branched chain alkyl of 1 to 24 carbon atoms or straight or branched chain alkenyl of 2 to 18 carbon atoms, each substituted by one or more —OH, —OCOE₁₁, —NH₂, —NHCOE₁₁ or glycidyloxy groups, or by mixtures thereof, or said alkyl or said alkenyl interrupted by one or more —O—,
or is a compound of formula (I) wherein,
G₁ is hydrogen,
G₂ is —CF₃,
E₁ is hydrogen, straight or branched alkyl of 4 to 24 carbon atoms or phenylalkyl of 7 to 15 carbon atoms, and
E₂ is straight or branched chain alkyl of 1 to 24 carbon atoms or straight or branched chain alkenyl of 2 to 18 carbon atoms, each substituted by one or more —OH, —OCOE₁₁, —NH₂, —NHCOE₁₁ or glycidyloxy groups, or by mixtures thereof, or said alkyl or said alkenyl interrupted by one or more —O—.

In another specific embodiment of the invention the hydroxyphenylbenzotriazole UV absorbers of formula (II) are of formula (IIA) 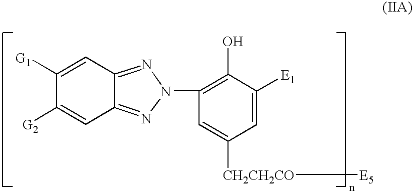
wherein
G₁ is hydrogen,
G₂ is —CF₃,
E₁ is hydrogen, straight or branched alkyl of 4 to 24 carbon atoms or phenylalkyl of 7 to 15 carbon atoms,
E₅ is —OE₆ or —NE₇E₈ where
E₆ is hydrogen, straight or branched chain C₁-C₂₄alkyl which is unsubstituted or substituted by one or more OH groups, or —OE₆ is —(OCH₂CH₂)_{w}OH or —(OCH₂CH₂)_{w}OE₂₁where w is 1 to 12 and E₂₁ is alkyl of 1 to 12 carbon atoms, and
E₇ and E₈ are independently hydrogen, alkyl of 1 to 18 carbon atoms, straight or branched chain C₃-C₁₈alkyl which is interrupted by —O—, —S— or —NE₁₁-, C₅-C₁₂cycloalkyl, C₆-C₁₄aryl or C₁-C₃hydroxylalkyl, or E₇ and E₈ together with the N atom are a pyrrolidine, piperidine, piperazine or morpholine ring.

In a further specific embodiment the hydroxyphenylbenzotriazole UV absorbers of formula (III) are of formula (IIIA) 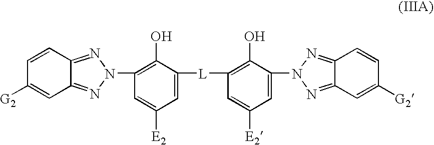
wherein
G₂ and G₂′ are independently hydrogen or —CF₃, where at least one of G₂ and G₂′ is —CF₃,
E₂ is straight or branched chain alkyl of 1 to 24 carbon atoms or straight or branched chain alkenyl of 2 to 18 carbon atoms, each substituted by one or more —OH, —OCOE₁₁, —NH₂, —NHCOE₁₁ or glycidyloxy groups, or by mixtures thereof, or said alkyl or said alkenyl interrupted by one or more —O—,
E₂′ is straight or branched alkyl chain of 1 to 24 carbon atoms, straight or branched chain alkenyl of 2 to 18 carbon atoms, cycloalkyl of 5 to 12 carbon atoms, phenylalkyl of 7 to 15 carbon atoms, phenyl, or said phenyl or said phenylalkyl substituted on the phenyl ring by 1 to 3 alkyl of 1 to 4 carbon atoms; or
E₂′ is straight or branched chain alkyl of 1 to 24 carbon atoms or straight or branched chain alkenyl of 2 to 18 carbon atoms substituted by one or more —OH, —OCOE₁₁, —NH₂, —NHCOE₁₁ or glycidyloxy groups, or by mixtures thereof, or said alkyl or said alkenyl interrupted by one or more —O—,
L is methylene.

Individual hydroxyphenylbenzotriazole UV absorbers are selected from the group consisting of
(a) 3-(5-trifluoromethyl-2H-benzotriazol-2-yl)-5-tert-butyl-4-hydroxyhydrocinnamic acid;
(b) methyl 3-(5-trifluoromethyl-2H-benzotriazol-2-yl)-5-tert-butyl-4-hydroxyhydrocinnamate;
(c) isooctyl 3-(5-trifluoromethyl-2H-benzotriazol-2-yl)-5-tert-butyl-4-hydroxyhydrocinnamate;
(d) 5-trifluoromethyl-2-[2-hydroxy-5-(3-hydroxypropyl)phenyl]-2H-benzotriadazole;
(e) 5-trifluoromethyl-2-[2-hydroxy-3-α-cumyl-5-(2-hydroxyethyl)phenyl]-2H-benzotriazole;
(f) 5-trifluoromethyl-2-[2-hydroxy-3-α-cumyl-5-(3-hydroxypropyl)phenyl]-2H-benzotriazole;
(g) 5-trifluoromethyl-2-[2-hydroxy-3-tert-butyl-5-(3-hydroxypropyl)phenyl)-2H-benzotriazole;
(h) 5-trifluoromethyl-2-[2-hydroxy-3-tert-butyl-5-(2-hydroxyethyl)phenyl]-2H-benzotriazole;
(i) 5-trifluoromethyl-2-[2-hydroxy-5-(2-hydroxyethyl)phenyl]-2H-benzotriazole;
(j) isooctyl 3-(5-chloro-2H-benzotriazol-2-yl)-5-tert-butyl-4-hydroxyhydrocinnamate;
(k) isooctyl 3-(5-phenylsulfonyl-2H-benzotriazol-2-yl)-5-tert-butyl-4-hydroxyhydrocinnamate;
(l) methyl 3-(5-phenylsulfonyl-2H-benzotriazol-2-yl)-5-tert-butyl-4-hydroxyhydrocinnamate;
(m) 3-(5-phenylsulfonyl-2H-benzotriazol-2-yl)-5-tert-butyl-4-hydroxyhydrocinnamic acid;
(n) 3-(5-trifluoromethyl-2H-benzotriazol-2-yl)-α-cumyl-4-hydroxyhydrocinnamic acid;
(o) isooctyl 3-(5-chloro-2H-benzotriazol-2-yl)-5-tert-butyl-4-hydroxyhydrocinnamate;
(p) methyl 3-(5-chloro-2H-benzotriazol-2-yl)-5-tert-butyl-4-hydroxyhydrocinnamate;
(q) 3-(5-chloro-2H-benzotriazol-2-yl)-5-tert-butyl-4-hydroxyhydrocinnamic acid;
(r) methyl 3-(5-fluoro-2H-benzotriazol-2-yl)-5-tert-butyl-4-hydroxyhydrocinnamate;
(s) 5-trifluoromethyl-2-[2-hydroxy-3-tert-butyl-4-(2-hydroxyethoxy)phenyl]-2H-benzotriazole;
(t) 5-chloro-2-[2-hydroxy-3-tert-butyl-4-(2-hydroxyethoxy)phenyl]-2H-benzotriazole and
(u) 5-(methoxycarbonylmethylsulfonyl)-3,5-di-tert-butyl-2-hydroxyphenyl-2H-benzotriazole.

The plastic containers and films are rigid or flexible mono- and/or multi-layered packaging materials. The containers and films may comprise polyesters, polyolefins, polyolefin copolymers such as ethylene-vinyl acetate, polystyrene, poly(vinyl chloride), poly(vinylidene chloride), polyamides, cellulosics, polycarbonates, ethylene-vinyl alcohol, poly(vinyl alcohol), styrene-acrylonitrile and ionomers and mixtures or multi-layers of these polymers.

Preferred is a method in which component (a) is a polyester or a polyamide, more preferably a polyester.

The polyesters which may be used in the compositions of this invention include linear, thermoplastic, crystalline or amorphous polyesters produced by conventional polymerization techniques from one or more diols and one or more dicarboxylic acids. The polyesters normally are molding grade and have an inherent viscosity (I.V.) of about 0.4 to about 1.2. For instance, polyesters comprise at least about 50 mole percent terephthalic acid residues and at least about 50 mole percent ethylene glycol and/or 1,4-cyclohexanedimethanol residues. For example, the present polyesters are those containing from about 75 to 100 mole percent terephthalic acid residues and from about 75 to 100 mole percent ethylene glycol residues.

The diol components of the described polyesters may be selected from ethylene glycol, 1,4-cyclohexanedimethanol, 1,2-propanediol, 1,3-propanediol, 1,4-butanediol, 2,2-dimethyl-1,3-propanediol, 1,6-hexanediol, 1,2-cyclohexanediol, 1,4-cyclohexanediol, 1,2-cyclohexanedimethanol, 1,3-cyclohexanedimethanol, X,8-bis(hydroxymethyl)-tricyclo-[5.2.1.0]-decane wherein X represents 3, 4, or 5; and diols containing one or more oxygen atoms in the chain e.g., diethylene glycol, triethylene glycol, dipropylene glycol, tripropylene glycol and the like. In general, these diols contain 2 to 18, for instance 2 to 8 carbon atoms. Cycloaliphatic diols can be employed in their cis or trans configuration or as mixtures of both forms.

The acid components (aliphatic, alicyclic, or aromatic dicarboxylic acids) of the linear polyester are selected, for example, from terephthalic acid, isophthalic acid, 1,4-cyclohexanedicarboxylic acid, 1,3-cyclohexanedicarboxylic acid, succinic acid, glutaric acid, adipic acid, sebacic acid, 1,12-dodecanedioic acid, 2,6-naphthalene-dicarboxylic acid and the like. In the polymer preparation, functional acid derivative thereof such as the dimethyl, diethyl, or dipropyl ester of the dicarboxylic acid are often employed. The anhydrides or acid halides of these acids also may be employed where practical.

The linear polyesters may be prepared according to procedures well known in the art. For example, a mixture of one or more dicarboxylic acids, for instance aromatic dicarboxylic acids, or ester forming derivatives thereof, and one or more diols may be heated in the presence of esterification and/or poly-esterification catalysts at temperatures in the range of 150° to 300° C. and pressures of atmospheric to 0.2 mm Hg. Normally, the dicarboxylic acid or derivative thereof is esterified or transesterified with the diol(s) at atmospheric pressure and at a temperature at the lower end of the specified range. Polycondensation then is effected by increasing the temperature and lowering the pressure while excess diol is removed from the mixture. Solid state polymerization may be employed to achieve final polymer I.V. in a useful range for films and molded containers.

The novel polyester compositions provided by this invention are useful in the manufacture of containers or packages for comestibles such as beverages and food. By the use of known heat-setting techniques, certain of the polyesters are, in terms of color, I.V. and heat distortion, stable at temperatures up to about 100° C. Such stability characteristics are referred to herein as “hot-fill” stability. Articles molded from these polyesters exhibit good thin-wall rigidity, excellent clarity and good barrier properties with respect to moisture and atmospheric gases, particularly carbon dioxide and oxygen.

Rigid containers may be manufactured by known mechanical processes:
a) Single-stage blow molding such as performed on Nissei, Aoki, or Uniloy machines,
b) Two-stage, injection molding of pre-forms such as on Netstal or Husky machines, and pre-forms converted to bottles by blow molding (e.g., on Sidel, Corpoplast and Krones machines),
c) Integrated blow molding of pre-forms to bottles, such as processes conducted on Sipa, Krupp Kautex, or Husky ISB machines, and
d) Stretch blow molding (SBM) of pre-forms to bottles.

The pre-forms may be mono-layer or multi-layer in construction. The bottles may optionally be post-treated to alter the inner wall properties. Bottles may optionally be surface treated on the exterior such as by application of surface coatings. UV absorbers and other known stabilizers may be present in such added surface coatings.

The linear polyesters for use in articles having “hot-fill” stability comprise for example poly(ethylene terephthalate), poly(ethylene terephthalate) wherein up to 5 mole percent of the ethylene glycol residues have been replaced with residues derived from 1,4-cyclohexanedimethanol and poly(ethylene 2,6-naphthalenedicarboxylate), wherein the polyesters have been sufficiently heat set and oriented by methods well known in the art to give a desired degree of crystallinity. By definition, a polymer is “hot-fill” stable at a prescribed temperature when less than 2% change in volume of a container manufactured therefrom occurs upon filling the same with a liquid at the temperature. For the manufacture of blow-molded beverage bottles, polyesters have for instance an I.V. of 0.65 to 0.85, and a Tg of >70° C., and film sections cut from the bottle have a Water Vapor Transmission Rate of 1.5 to 2.5 g mils/100 in.² −24 hours, a Carbon Dioxide Permeability of 20 to 30 cc. mils/100 in.² −24 hours -atm., and an Oxygen Permeability of 4 to 8 cc. mils/100 in.² −24 hours -atm. The Tg is determined by Differential Scanning Calorimetry at a scan rate of 20 Centigrade Degrees/min., the Oxygen Permeability by the standard operating procedure of a MOCON OXTRAN 100 instrument of Modern Controls, Inc., of Elk Riber, Minn., and the Carbon Dioxide Permeability by the standard operating procedure of a MOCON PERMATRAN C II, also of Modern Controls.

For example component (a) is poly(ethylene terephthalate) or polyamide 6,6.

According to the present invention, mixtures of stabilizers of component (b) may be employed, for example a mixture of at least one benzotriazole and at least one s-triazine or a mixture of two or more benzotriazoles or two or more s-triazines. The UV absorbers of component (b) are all highly durable, but have different UV light absorbing characteristics depending on their substitution pattern. By selection of particular combinations of UV absorbers, one may optimize the UV absorbing characteristics and the color of the compositions of this invention.

According to the present invention, the compositions may also comprise another UV absorber not of the reactable class described herein. Suitable additional UV absorbers are for example durable benzotriazole and triazines. The present compositions may comprise additional commercial benzotriazole and/or s-triazine UV absorbers as described herein.

In a specific embodiment of the invention the container or film comprises at least one hydroxyphenylbenzotriazole moiety and at least one further moiety selected from the group consisting of the s-triazine moieties, or which comprises a mixture of two or more different hydroxyphenylbenzotriazole moieties.

Preferably the container or film additionally comprises at least one UV absorber selected from the group consisting of 2-(2-hydroxy-3,5-di-α-cumyl)-2H-benzotriazole, 5-chloro-2-(2-hydroxy-3-tert-butyl-5-methylphenyl)-2H-benzotriazole, 5-chloro-2-(2-hydroxy-3,5-di-tert-butylphenyl)-2H-benzotriazole and 4,6-diphenyl-2-(4-hexyloxy-2-hydroxyphenyl)-s-triazine.

The contents to be protected by the compositions and methods of the instant invention include foodstuffs such as fruit juices, soft drinks, beer, wines, food products and dairy products, and personal care products, cosmetics, shampoos, vitamins, pharmaceuticals, inks, dyes and pigments.

Typical multi-layer constructions have two or more layer laminates, manufactured either by thermoforming, or extrusion of multi-layer flexible films, or extrusion of bottle “preforms” or “parissons” followed by subsequent blow molding of the preforms into bottles.

For both films and rigid packaging (bottles), typically the exterior layer, and innermost layer contacting the contents, are composed of polyesters such as PET or PEN [poly(ethylene naphthalate)], polypropylene, or polyethylene such as HDPE. The middle layers, often called ‘barrier’ or ‘adhesive’ or ‘tie’ layers, are composed of one or more combinations of either PET, PEN, carboxylated polyethylene ionomer such as Surlyn®, vinyl alcohol homopolymers or copolymers such as poly(vinyl alcohol), partially hydrolyzed poly(vinyl acetate), poly(ethylene-co-vinyl alcohol) such as EVOH or EVAL, nylons or polyamides such as Selar® (DuPont) or polyamides based on metaxylenediamine (sometimes called nylon MXD-6), or polyvinylidene chloride (PVDC), or polyurethanes. For packaging of meats and vegetables, where a controlled rate of ‘respiration’ or oxygen and moisture transport is desired, polystyrenes and cellulosics are used as a packaging component.

For instance the plastic container or film is rigid or flexible and is mono- or multi-layered, wherein each layer is comprised of one or more polymers selected from the group consisting of polyesters, polyolefins, polyolefin copolymers, ethylene-vinyl acetate, polystyrene, poly(vinyl chloride), poly(vinylidene chloride), polyamides, cellulosics, polycarbonates, ethylene-vinyl alcohol, poly(vinyl alcohol), poly(vinyl alcohol) copolymers, styrene- acrylonitrile, ionomers, partially hydrolyzed poly(vinyl acetate), poly(ethylene-co-vinyl alcohol), polyvinylidene chloride, polyurethanes, PVDC and epoxies.

In a specific embodiment of the invention at least one layer is comprised of a polymer selected from the group consisting of poly(ethylene terephthalate), polyethylene and polypropylene.

Optionally, the stabilizers of component (b) and optional further additives can be incorporated into coatings which are applied to the outer surface of e.g. rigid containers. Examples of exterior coatings include PVDC, or epoxies (such as Bairocace® technology and polyolefins used as “shrink wrap.”

In a further embodiment of the invention the UV absorbing moieties of component (b) are incorporated into a coating applied to the outer surface of the container or film.

The present containers and films are comprised for example of polyesters, for example poly(ethylene terephthalate) (PET. Where the packaging material is a multi-layer system, layers of any suitable plastic may be employed.

The present hydroxyphenylbenzotriazole UV absorbers are reacted into suitable polymer components of containers and films via condensation reactions. As discussed above, the present containers and films may comprise any of a number of known plastics. However, the reactable benzotriazole UV absorbers are necessarily reacted into a polymer component able to undergo condensation reactioris, for example polyesters or polyamides.

The term “reacted into” in this context means “grafted to”. The present UV absorbers are permanently and covalently bonded or grafted to the polymer component able to undergo condensation reactions.

The present hydroxyphenylbenzotriazole UV absorbers may be reacted into a component of a container or film during a polymerization process or may be reacted with a partially formed polymer or may be reacted with a finished polymer. The present UV absorbers may be reacted with monomers prior to their polymerization into a polymer component, or may be reacted with a partially formed polymer at any point during a polymerization process. If reacted with a finished polymer, the present UV absorbers are necessarily grafted onto the polymer via reaction with the polymer's end groups.

The hydroxyphenylbenzotriazole UV absorbers may be grafted into a polymer at a high level, thereby providing a masterbatch of UV absorbing polymer component. Such a masterbatch may further be let down with a conventional polymer. A masterbatch may contain component (b) in a concentration of, for example, about 2.5% to about 95% by weight based on the weight of the polymer component (a). For example, a masterbatch of this invention may contain component (b) in a concentration of, for example, about 5% to about 80%, or about 10% to about 70%, or about 20% to about 50%, or about 25% to about 35%.

The polymer reacted, or grafted with the present reactable, durable UV absorbers, for example the rnasterbatches described above, are considered UV absorbing polymers.

The condensation-reactable hydroxyphenylbenzotriazole UV absorbers described herein are in their “pre-reaction” form, that is in the form to be reacted with the appropriate polymer. Once reacted with the polymer component, the present UV absorbers are part of a “UV absorbing polymer” as “UV absorbing moieties”. Said moieties are equivalent to the pre-reaction UV absorber in structure less the chemical group discharged in the condensation reaction, for example less a hydrogen, hydroxy or alkoxy. Alternatively, the UV moiety may gain a chemical group, for example, a hydrogen may be gained if a reaction between a hydroxy of a polymer and an epoxy of a UV absorber takes place. The bonded moieties are derived from the reactable UV absorbers disclosed herein.

The reactable groups of the present hydroxyphenylbenzotriazole UV absorbers of component (b) are typical groups thay may under condensation reactions, for example carboxylic acids, esters, alcohols, epoxides, glycidyl groups, amides and amines. The hydroxyphenylbenzotriazole UV absorbers may contain a single reactive group, and hence would function as a chain termination agent. Alternatively, they may have 2 or more reactive groups, and then have the ability to copolymerize into the reactable polymer.

Suitable catalysts may be employed for the present UV absorber-polymer condensation reactions, for example, suitable esterification catalysts.

Typically the UV absorbing moieties of component (b) are present from about 0.1 to about 20% by weight based on the weight of the plastic container or film.

The instant plastic container or film stabilized by a compound or compounds of component (b) may also optionally contain from about 0.01 to about 10% by weight; for instance from about 0.025 to about 5% by weight, for example from about 0.1 to about 3% by weight of additional coadditives such as antioxidants, other UV absorbers, hindered amines, phosphites or phosphonites, hydroxylamines, nitrones, benzofuran-2-ones, thiosynergists, polyamide stabilizers, metal stearates, nucleating agents, fillers, reinforcing agents, lubricants, emulsifiers, dyes, pigments, optical brighteners, flame retardants, antistatic agents, blowing agents and the like.

The stabilizers of the instant invention may readily be incorporated into the present container or film compositions by conventional techniques, at any convenient stage prior to the manufacture of articles therefrom. For example, the stabilizer may be mixed with the polymer in dry powder form, or a suspension or emulsion of the stabilizer may be mixed with a solution, suspension, or emulsion of the polymer. The resulting stabilized compositions of the invention may optionally also contain from about 0.01 to about 10%, for example from about 0.025 to about 5%, for instance from about 0.1 to about 3% by weight of various conventional stabilizer coadditives, such as the materials listed below, or mixtures thereof.

1. Antioxidants

1.1. Alkylated monophenols, for example 2,6-di-tert-butyl-4-methylphenol, 2-tert-butyl-4,6-di-methylphenol, 2,6-di-tert-butyl-4-ethylphenol, 2,6-di-tert-butyl-4-n-butylphenol, 2,6-di-tert-butyl-4-isobutylphenol, 2,6-dicyclopentyl-4-methylphenol, 2-(α-methylcyclohexyl)-4,6-dimethylphenyl, 2,6-dioctadecyl-4-methylphenol, 2,4,6-tricyclohexylphenol, 2,6-di-tert-butyl-4-methoxymethylphenol, nonylphenols which are linear or branched in the side chains, for example, 2,6-di-nonyl-4-methylphenol, 2,4-dimethyl-6-(1-methylundec-1-yl)phenol, 2,4-di-methyl-6-(1-methylheptadec-1-yl)phenol, 2,4-dimethyl-6-(1-methyltridec-1-yl)phenol and mixtures thereof.

1.2. Alkylthiomethylphenols, for example 2,4-dioctylthiomethyl-6-tert-butylphenol, 2,4-dioctyl-thiomethyl-6-methylphenol, 2,4-dioctylthiomethyl-6-ethylphenol, 2,6-di-dodecylthiomethyl-4- nonylphenol.

1.3. Hydroquinones and alkylated hydroquinones, for example 2,6-di-tert-butyl-4-methoxy-phenol, 2,5-di-tert-butylhydroquinone, 2,5-di-tert-amylhydroquinone, 2,6-diphenyl-4-octa-decyloxyphenol, 2,6-di-tert-butylhydroquinone, 2,5-di-tert-butyl-4-hydroxyanisole, 3,5-di-tert-butyl-4-hydroxyanisole, 3,5-di-tert-butyl-4-hydroxyphenyl stearate, bis-(3,5-di-tert-butyl-4-hydroxyphenyl) adipate.

1.4. Tocopherols, for example α-tocopherol, β-tocopherol, γ-tocopherol, δ-tocopherol and mixtures thereof (Vitamin E).

1.5. Hydroxylated thiodiphenyl ethers, for example 2,2′-thiobis(6-tert-butyl-4-methylphenol), 2,2′-thiobis(4-octylphenol), 4,4′-thiobis(6-tert-butyl-3-methylphenol), 4,4′-thiobis(6-tert-butyl-2-methylphenol), 4,4′-thiobis-(3,6-di-sec-amylphenol), 4,4′-bis(2,6-dimethyl-4-hydroxyphenyl)-disulfide.

1.6. Alkylidenebisphenols, for example 2,2′-methylenebis(6-tert-butyl-4-methylphenol), 2,2′-methylenebis(6-tert-butyl-4-ethylphenol), 2,2′-methylenebis[4-methyl-6-(α-methylcyclohexyl)-phenol], 2,2′-methylenebis(4-methyl-6-cyclohexylphenol), 2,2′-methylenebis(6-nonyl-4-me-thylphenol), 2,2′-methylenebis(4,6-di-tert-butylphenol), 2,2′-ethylidenebis(4,6-di-tert-butylphenol), 2,2′-ethylidenebis(6-tert-butyl-4-isobutylphenol), 2,2′-methylenebis[6-(α-methylbenzyl)-4-nonylphenol], 2,2′-methylenebis[6-(α,α-dimethylbenzyl)-4-nonylphenol], 4,4′-methylenebis-(2,6-di-tert-butylphenol), 4,4′-methylenebis(6-tert-butyl-2-methylphenol), 1,1-bis(5-tert-butyl-4-hydroxy-2-methylphenyl)butane, 2,6-bis(3-tert-butyl-5-methyl-2-hydroxybenzyl)-4-methyl-phenol, 1,1,3-tris(5-tert-butyl-4-hydroxy-2-methylphenyl)butane, 1,1-bis(5-tert-butyl-4-hydroxy-2-methyl-phenyl)-3-n-dodecylmercaptobutane, ethylene glycol bis[3,3-bis(3-tert-butyl-4-hydroxyphenyl)butyrate], bis(3-tert-butyl-4-hydroxy-5-methyl-phenyl)dicyclopentadiene, bis[2-(3′tert-butyl-2-hydroxy-5-methylbenzyl)-6-tert-butyl-4-methylphenyl]terephthalate, 1,1-bis-(3,5-dimethyl-2-hydroxyphenyl)butane, 2,2-bis-(3,5-di-tert-butyl-4-hydroxyphenyl)propane, 2,2-bis-(5-tert-butyl-4-hydroxy2-methylphenyl)-4-n-dodecylmercaptobutane, 1,1,5,5-tetra-(5-tert-butyl-4-hydroxy-2-methylphenyl)pentane.

1.7. Benzyl compounds, for example 3,5,3′,5′-tetra-tert-butyl-4,4′-dihydroxydibenzyl ether, octadecyl-4-hydroxy-3,5-dimethylbenzylmercaptoacetate, tridecyl-4-hydroxy-3,5-di-tert-butyl-benzylmercaptoacetate, tris(3,5-di-tert-butyl-4-hydroxybenzyl)amine, 1,3,5-tri-(3,5-di-tert-butyl-4-hydroxybehzyl)-2,4,6-trimethylbenzene, di-(3,5-di-tert-butyl-4-hydroxybenzyl) sulfide, 3,5-di-tert-butyl-4-hydroxybenzyl-mercapto-acetic acid isooctyl ester, bis-(4-tert-butyl-3-hydroxy-2,6-dimethylbenzyl)dithiol terephthalate, 1,3,5-tris-(3,5-di-tert-butyl-4-hydroxybenzyl) isocyanurate, 1,3,5-tris-(4-tert-butyl-3-hydroxy-2,6-dimethylbenzyl) isocyanurate, 3,5-di-tert-butyl-4-hydroxybenzyl-phosphoric acid dioctadecyl ester and 3,5-di-tert-butyl-4-hydroxy-benzyl-phosphoric acid monoethyl ester, calcium-salt.

1.8. Hydroxybenzylated malonates, for example dioctadecyl-2,2-bis-(3,5-di-tert-butyl-2-hydroxybenzyl)-malonate, di-octadecyl-2-(3-tert-butyl-4-hydroxy-5-methylbenzyl)-malonate, di-dodecylmercaptoethyl-2,2 bis (3,5-di-tert-butyl-4-hydroxybenzyl)malonate, bis[4-(1,1,3,3-tetramethylbutyl)phenyl]-2,2-bis(3,5-di-tert-butyl-4-hydroxybenzyl)malonate.

1.9. Aromatic hydroxybenzyl compounds, for example 1,3,5-tris-(3,5-di-tert-butyl-4-hydroxy-benzyl)-2,4,6-trimethylbenzene, 1,4-bis(3,5-di-tert-butyl-4-hydroxybenzyl)-2,3,5,6-tetrame-thylbenzene, 2,4,6-tris(3,5-di-tert-butyl-4-hydroxybenzyl)phenol.

1.10. Triazine compounds, for example 2,4-bis(octylmercapto)-6-(3,5-di-tert-butyl-4-hydroxy-anilino)-1,3,5-triazine, 2-octylmercapto-4,6-bis(3,5-di-tert-butyl-4-hydroxyanilino)-1,3,5-triazine, 2-octylmercapto-4,6-bis(3,5-di-tert-butyl-4-hydroxyphenoxy)-1,3,5-triazine, 2,4,6-tris-(3,5-di-tert-butyl-4-hydroxyphenoxy)-1,2,3-triazine, 1,3,5-tris-(3,5-di-tert-butyl-4-hydroxy-benzyl)isocyanurate, 1,3,5-tris(4-tert-butyl-3-hydroxy-2,6-dimethylbenzyl)isocyanurate, 2,4,6-tris(3,5-di-tert-butyl-4-hydroxyphenylethyl)-1,3,5-triazine, 1,3,5-tris(3,5-di-tert-butyl-4-hydroxy-phenylpropionyl)-hexahydro-1,3,5-triazine, 1 ,3,5-tris(3,5-dicyclohexyl-4-hydroxybenzyl)iso-cyanurate.

1.11. Benzylrhosphonates, for example dimethyl-2,5-di-tert-butyl-4-hydroxybenzylphospho-nate, diethyl-3,5-di-tert-butyl-4-hydroxybenzylphosphonate, dioctadecyl 3,5-di-tert-butyl-4-hydroxybenzylphosphonate, dioctadecyl-5-tert-butyl-4-hydroxy-3-methylbenzylphosphonate, the calcium salt of the monoethyl ester of 3,5-di-tert-butyl-4-hydroxybenzylphosphonic acid.

1.12. Acylaminophenols, for example 4-hydroxy-lauric acid anilide, 4-hydroxy-stearic acid anilide, 2,4-bis-octylmercapto-6-(3,5-tert-butyl-4-hydroxyanilino)-s-triazine and octyl-N-(3,5-di-tert-butyl-4-hydroxyphenyl)-carbamate.

1.13. Esters of β-(3.5-di-tert-butyl-4-hydroxyphenyl)propionic acid with mono- or polyhydric alcohols, e.g. with methanol, ethanol, n-octanol, i-octanol, octadecanol, 1,6-hexanediol, 1,9-nonanediol, ethylene glycol, 1,2-propanediol, neopentyl glycol, thiodiethylene glycol, diethylene glycol, triethylene glycol, pentaerythritol, tris(hydroxyethyl) isocyanurate, N,N′-bis(hydroxyethyl)oxamide, 3-thiaundecanol, 3-thiapentadecanol, trimethylhexanediol, trimethylolpropane, 4-hydroxymethyl-1-phospha-2,6,7-trioxabicyclo[2.2.2]octane.

1.14. Esters of β-(5-tert-butyl-4-hydroxy-3-methylphenyl)propionic acid with mono- or polyhydric alcohols, e.g. with methanol, ethanol, n-octanol, i-octanol, octadecanol, 1,6-hexanediol, 1,9-nonanediol, ethylene glycol, 1,2-propanediol, neopentyl glycol, thiodiethylene glycol, diethylene glycol, triethylene glycol, pentaerythritol, tris(hydroxyethyl) isocyanurate, N,N′-bis(hydroxyethyl)oxamide, 3-thiaundecanol, 3-thiapentadecanol, trimethylhexanediol, trimethylolpropane, 4-hydroxymethyl-1-phospha-2,6,7-trioxabicyclo[2.2.2]octane.

1.15. Esters of β-(3.5-dicyclohexyl-4-hydroxyphenyl)propionic acid with mono- or polyhydric alcohols, e.g. with methanol, ethanol, octanol, octadecanol, 1,6-hexanediol, 1,9-nonanediol, ethylene glycol, 1,2-propanediol, neopentyl glycol, thiodiethylene glycol, diethylene glycol, triethylene glycol, pentaerythritol, tris(hydroxyethyl)isocyanurate, N,N′-bis(hydroxy-ethyl)oxamide, 3-thiaundecanol, 3-thiapentadecanol, trimethylhexanediol, trimethylolpropane, 4-hydroxymethyl-1-phospha-2,6,7-trioxabicyclo[2.2.2]octane.

1.16. Esters of 3.5-di-tert-butyl-4-hydroxyphenyl acetic acid with mono- or polyhydric alcohols, e.g. with methanol, ethanol, octanol, octadecanol, 1,6-hexanediol, 1,9-nonanediol, ethylene glycol, 1,2-propanediol, neopentyl glycol, thiodiethylene glycol, diethylene glycol, triethylene glycol, pentaerythritol, tris(hydroxyethyl)isocyanurate, N,N′-bis(hydroxyethyl)ox-amide, 3-thiaundecanol, 3-thiapentadecanol, trimethylhexanediol, trimethylolpropane, 4-hydroxymethyl-1-phospha-2,6,7-trioxabicyclo[2.2.2]octane.

1.17. Amides of β-(3.5-di-tert-butyl-4-hydroxyghenyl)propionic acid e.g. N,N′-bis(3,5-di-tert-butyl-4-hydroxyphenylpropionyl)hexamethylenediamide, N,N′-bis(3,5-di-tert-butyl-4-hydroxy-phenylpropionyl)trimethylenediamide, N,N′-bis(3,5-di-tert-butyl-4-hydroxyphenylpropionyl)hydrazide, N,N′-bis[2-(3-[3,5-di-tert-butyl-4-hydroxyphenyl]propionyloxy)ethyl]oxamide (Naugard®XL-1 supplied by Uniroyal).

1.18. Ascorbic acid (vitamin C)

1.19. Aminic antioxidants, for example N,N′-di-isopropyl-p-phenylenediamine, N,N′-di-sec-butyl-p-phenylenediamine, N,N′-bis(1,4-dimethylpentyl)-p-phenylenediamine, N,N′-bis(1-ethyl-3-methylpentyl)-p-phenylenediamine, N,N′-bis(1-methylheptyl)-p-phenylenediamine, N,N′-dicyclohexyl-p-phenylenediamine, N,N′-diphenyl-p-phenylenediamine, N,N′-bis(2-naphthyl)-p-phenylenediamine, N-isopropyl-N′-phenyl-p-phenylenediamine, N-(1,3-dimethylbutyl)-N′-phenyl-p-phenylenediamine, N-(1-methylheptyl)-N′-phenyl-p-phenylenediamine, N-cyclo-hexyl-N′-phenyl-p-phenlenediamine, 4-(p-toluenesulfamoyl)diphenylamine, N,N′-dimethyl-N,N′-di-sec-butyl-p-phenylenediamine, diphenylamine, N-allyldiphenylamine, 4-isopropoxy-diphenylamine, N-phenyl-1-naphthylamine, N-(4-tert-octylphenyl)-1-naphthylamine, N-phenyl-2-naphthylamine, octylated diphenylamine, for example p,p′-di-tert-octyldiphenylamine, 4-n-butylaminophenol, 4-butyrylaminophenol, 4-nonanoylaminophenol, 4-dodecanoylaminophenol, 4-octadecanoylaminophenol, bis(4-methoxyphenyl)amine, 2,6-di-tert-butyl-4-dimethylaminomethylphenol, 2,4′-diaminodiphenylmethane, 4,4′-diaminodiphenylmethane, N,N,N′,N′-tetramethyl-4,4′-diaminodiphenylmethane, 1,2-bis[(2-methylphenyl)amino]ethane, 1,2-bis(phenylamino)propane, (o-tolyl)biguanide, bis[4-(1′,3′-dimethylbutyl)phenyl]amine, tert-octylated N-phenyl-1-naphthylamine, a mixture of mono- and dialkylated tert-butyl/tert-octyldiphenylamines, a mixture of mono- and dialkylated nonyldiphenylamines, a mixture of mono- and dialkylated dodecyldiphenylamines, a mixture of mono- and dialkylated isopropyl/isohexyldiphenylamines, a mixture of mono- and dialkylated tert-butyl-diphenylamines, 2,3-dihydro-3,3-dimethyl-4H-1,4-benzothiazine, phenothiazine, a mixture of mono- and dialkylated tert-butyl/tert-octylphenothiazines, a mixture of mono- and dialkylated tert-octyl-phenothiazines, N-allylphenothiazin, N,N,N′,N′-tetraphenyl-1,4-diaminobut-2-ene, N,N-bis(2,2,6,6-tetramethyl-piperid-4-yl-hexamethylenediamine, bis(2,2,6,6-tetramethylpiperid-4-yl)sebacate, 2,2,6,6-tetramethylpiperidin-4-one, 2,2,6,6-tetramethylpiperidin-4-ol.

2. UV Absorbers and Light Stabilizers

2.1. 2-(2-Hydroxyphenyl)-2H-benzotriazoles, for example known commercial hydroxyphenyl-2H-benzotriazoles and benzotriazoles as disclosed in, U.S. Pat. Nos. 3,004,896; 3,055,896; 3,072,585; 3,074,910; 3,189,615; 3,218,332; 3,230,194; 4,127,586; 4,226,763; 4,275,004; 4,278,589; 4,315,848; 4,347,180; 4,383,863; 4,675,352; 4,681,905, 4,853,471; 5,268,450; 5,278,314; 5,280,124; 5,319,091; 5,410,071; 5,436,349; 5,516,914; 5,554,760; 5,563,242; 5,574,166; 5,607,987, 5,977,219 and 6,166,218 such as 2-(2-hydroxy-5-methylphenyl)-2H-benzotriazole, 2-(3,5-di-t-butyl-2-hydroxyphenyl)-2H-benzotriazole, 2-(2-hydroxy-5-t-butylphenyl)-2H-benzotriazole, 2-(2-hydroxy-5-t-octylphenyl)-2H-benzotriazole, 5-chloro-2-(3,5-di-t-butyl-2-hydroxyphenyl)-2H-benzotriazole, 5-chloro-2-(3-t-butyl-2-hydroxy-5-methylphenyl)-2H-benzotriazole, 2-(3-sec-butyl-5-t-butyl-2-hydroxyphenyl)-2H-benzotria-zole, 2-(2-hydroxy-4-octyloxyphenyl)-2H-benzotriazole, 2-(3,5-di-t-amyl-2-hydroxyphenyl)-2H-benzotriazole, 2-(3,5-bis-α-cumyl-2-hydroxyphenyl)-2H-benzotriazole, 2-(3-t-butyl-2-hydroxy-5-(2-(ω-hydroxy-octa-(ethyleneoxy)carbonyl-ethyl)-, phenyl)-2H-benzotriazole, 2-(3-dodecyl-2-hydroxy-5-methylphenyl)-2H-benzotriazole, 2-(3-t-butyl-2-hydroxy-5-(2-octyloxy-carbonyl)ethylphenyl)-2H-benzotriazole, dodecylated 2-(2-hydroxy-5-methylphenyl)-2H-benzotriazole, 2-(3-t-butyl-2-hydroxy-5-(2-octyloxycarbonylethyl)phenyl)-5-chloro-2H-benzotriazole, 2-(3-tert-butyl-5-(2-(2-ethylhexyloxy)-carbonylethyl)-2-hydroxyphenyl)-5-chloro-2H-benzotriazole, 2-(3-t-butyl-2-hydroxy-5-(2-methoxycarbonylethyl)phenyl)-5-chloro-2H-benzotriazole, 2-(3-t-butyl-2-hydroxy-5-(2-methoxycarbonylethyl)phenyl)-2H-benzotriazole, 2-(3-t-butyl-5-(2-(2-ethylhexyloxy)carbonylethyl)-2-hydroxyphenyl)-2H-benzotriazole, 2-(3-t-butyl-2-hydroxy-5-(2-isooctyloxycarbonylethyl)phenyl-2H-benzotriazole, 2,2′-methylene-bis(4-t-octyl-(6-2H-benzotriazol-2-yl)phenol), 2-(2-hydroxy-3-α-cumyl-5-t-octylphenyl)-2H-benzotria-zole, 2-(2-hydroxy-3-t-octyl-5-α-cumylphenyl)-2H-benzotriazole, 5-fluoro-2-(2-hydroxy-3,5-di-α-cumylphenyl)-2H-benzotriazole, 5-chloro-2-(2-hydroxy-3,5-di-α-cumylphenyl)-2H-benzo-triazole, 5-chloro-2-(2-hydroxy-3-c-cumyl-5-t-octylphenyl)-2H-benzotriazole, 2-(3-t-butyl-2-hydroxy-5-(2-isooctyloxycarbonylethyl)phenyl)-5-chloro-2H-benzotriazole, 5-trifluoromethyl-2-(2-hydroxy-3-α-cumyl-5-t-octylphenyl)-2H-benzotriazole, 5-trifluoromethyl-2-(2-hydroxy-5-t-octylphenyl)-2H-benzotriazole, 5-trifluoromethyl-2-(2-hydroxy-3,5-di-t-octylphenyl)-2H-benzo-triazole, methyl 3-(5-trifluoromethyl-2H-benzotriazol-2-yl)-5-t-butyl-4-hydroxyhydrocinnamate, 5-butylsulfonyl-2-(2-hydroxy-3-α-cumyl-5-t-octylphenyl)-2H-benzotriazole, 5-trifluormethyl-2-(2-hydroxy-3-α-cumyl-5-t-butylphenyl)-2H-benzotriazole, 5-trifluoromethyl -2-(2-hydroxy-3,5-di-t-butylphenyl)-2H-benzotriazole, 5-trifluoromethyl-2-(2-hydroxy-3,5-di-α-cumylphenyl)-2H-benzotriazole, 5-butylsulfonyl-2-(2-hydroxy-3,5-di-t-butylphenyl)-2H-benzotriazole and 5-phenylsulfonyl-2-(2-hydroxy-3,5-di-t-butylphenyl)-2H-benzotriazole.

2.2. 2-Hydroxybenzophenones, for example the 2,2′-dihydroxy, 4-hydroxy, 4-methoxy, 4-octyloxy, 4-decyloxy, 4-dodecyloxy, 4-benzyloxy, 4,2′,4′-trihydroxy and 2′-hydroxy-4,4′-dimethoxy derivatives.

2.3. Esters of substituted and unsubstituted benzoic acids, as for example 4-tertbutyl-phenyl salicylate, phenyl salicylate, octylphenyl salicylate, dibenzoyl resorcinol, bis(4-tert-butylbenzoyl) resorcinol, benzoyl resorcinol, 2,4-di-tert-butylphenyl 3,5-di-tert-butyl-4-hydroxybenzoate, hexadecyl 3,5-di-tert-butyl-4-hydroxybenzoate, octadecyl 3,5-di-tert-butyl-4-hydroxy-benzoate, 2-methyl-4,6-di-tert-butylphenyl 3,5-di-tert-butyl-4-hydroxybenzoate.

2.4. Acrylates and malonates, for example, α-cyano-β,β-diphenylacrylic acid ethyl ester or isooctyl ester, α-carbomethoxy-cinnamic acid methyl ester, α-cyano-β-methyl-p-methoxy-cinnamic acid methyl ester or butyl ester, a-carbomethoxy-p-methoxy-cinnamic acid methyl ester, N-(β-carbomethoxy-β-cyanovinyl)-2-methyl-indoline, Sanduvor® PR25, dimethyl p-methoxybenzylidenemalonate (CAS# 7443-25-6), and Sanduvor® PR31, di-(1,2,2,6,6-pentamethylpiperidin-4-yl) p-methoxybenzylidenemalonate (CAS #147783-69-5).

2.5. Nickel compounds, for example nickel complexes of 2,2′-thio-bis-[4-(1,1,3,3-tetramethyl-butyl)phenol], such as the 1:1 or 1:2 complex, with or without additional ligands such as n-butylamine, triethanolamine or N-cyclohexyldiethanolamine, nickel dibutyldithiocarbamate, nickel salts of the monoalkyl esters, e.g. the methyl or ethyl ester, of 4-hydroxy-3,5-di-tert-butylbenzylphosphonic acid, nickel complexes of ketoximes, e.g. of 2-hydroxy-4-methylphenyl undecylketoxime, nickel complexes of 1-phenyl-4-lauroyl-5-hydroxypyrazole, with or without additional ligands.

2.6. Sterically hindered amine stabilizers, for example 4-hydroxy-2,2,6,6-tetramethyl-piperidine, 1-allyl-4-hydroxy-2,2,6,6-tetramethylpiperidine, 1-benzyl-4-hydroxy-2,2,6,6-tetramethylpiperidine, bis(2,2,6,6-tetramethyl-4-piperidyl) sebacate, bis(2,2,6,6-tetramethyl-4-piperidyl) succinate, bis(1,2,2,6,6-pentamethyl-4-piperidyl) sebacate, bis(1-octyloxy-2,2,6,6-tetramethyl-4-piperidyl) sebacate, bis(1,2,2,6,6-pentamethyl-4-piperidyl) n-butyl-3,5-di-tert-butyl-4-hydroxybenzylmalonate, the condensate of 1-(2-hydroxyethyl)-2,2,6,6-tetramethyl-4-hydroxypiperidine and succinic acid, linear or cyclic condensates of N,N′-bis(2,2,6,6-tetramethyl-4-piperidyl)hexamethylenediamine and 4-tert-octylamino-2,6-dichloro-1,3,5-triazine, tris(2,2,6,6-tetramethyl-4-piperidyl) nitrilotriacetate, tetrakis(2,2,6,6-tetramethyl-4-piperidyl)-1,2,3,4-butane-tetracarboxylate, 1,1′-(1,2-ethanediyl)-bis(3,3,5,5-tetramethylpiperazinone), 4-benzoyl-2,2,6,6-tetramethylpiperidine, 4-stearyloxy-2,2,6,6-tetramethylpiperidine, bis(1,2,2,-6,6-pentamethylpiperidyl)-2-n-butyl-2-(2-hydroxy-3,5-di-tert-butylbenzyl) malonate, 3-n-octyl-7,7,9,9-tetramethyl-1,3,8-triazaspiro[4.5]decan-2,4-dione, bis(1-octyloxy-2,2,6,6-tetramethyl-piperidyl) sebacate, bis(1-octyloxy-2,2,6,6-tetramethylpiperidyl) succinate, linear or cyclic condensates of N,N′-bis-(2,2,6,6-tetramethyl-4-piperidyl)hexamethylenediamine and 4-morpholino-2,6-dichloro-1,3,5-triazine, the condensate of 2-chloro-4,6-bis(4-n-butylamino-2,2,6,6-tetramethylpiperidyl )-1,3,5-triazine and 1,2-bis(3-aminopropylamino)ethane, the condensate of 2-chloro-4,6-di-(4-n-butylamino-1,2,2,6,6-pentamethylpiperidyl)-1,3,5-triazine and 1,2-bis-(3-aminopropylamino)ethane, 8-acetyl-3-dodecyl-7,7,9,9-tetramethyl-1,3,8-triazaspiro[4.5]decane-2,4-dione, 3-dodecyl-1-(2,2,6,6-tetramethyl-4-piperidyl)pyrrolidin-2,5-dione, 3-dodecyl-1-(1,2,2,6,6-pentamethyl-4-piperidyl)pyrrolidine-2,5-dione, a mixture of 4-hexadecyloxy- and 4-stearyloxy-2,2,6,6-tetramethylpiperidine, a condensation product of N,N′-bis(2,2,6,6-tetramethyl-4-piperidyl)hexamethylenediamine and 4-cyclohexylamino-2,6-di-chloro-1,3,5-triazine, a condensation product of 1,2-bis(3-aminopropylamino)ethane and 2,4,6-trichloro-1,3,5-triazine as well as 4-butylamino-2,2,6,6-tetramethylpiperidine (CAS Reg. No. [136504-96-6]); N-(2,2,6,6-tetramethyl-4-piperidyl)-n-dodecylsuccinimid, N-(1,2,2,6,6-pentamethyl-4-piperidyl)-n-dodecylsuccinimid, 2-undecyl-7,7,9,9-tetramethyl-1-oxa-3,8-diaza-4-oxo-spiro[4,5]decane, a reaction product of 7,7,9,9-tetramethyl-2-cycloundecyl-1-oxa-3,8-diaza-4-oxospiro [4,5]decane and epichlorohydrin, 1,1-bis(1 ,2,2,6,6-pentamethyl-4-piperidyloxycarbonyl)-2-(4-methoxyphenyl)ethene, N,N′-bis-formyl-N,N′-bis(2,2,6,6-tetrame-thyl-4-piperidyl)hexamethylenediamine, diester of 4-methoxy-methylene-malonic acid with 1 ,2,2,6,6-pentamethyl-4-hydroxypiperidine, poly[methylpropyl-3-oxy-4-(2,2,6,6-tetramethyl-4-piperidyl)]siloxane, reaction product of maleic acid anhydride-α-olefin-copolymer with 2,2,6,6-tetramethyl-4-aminopiperidine or 1,2,2,6,6-pentamethyl-4-aminopiperidine.

The sterically hindered amine may also be one of the compounds described in U.S. Pat. No. 5,980,783, the relevant parts of which are hereby incorporated by reference, that is compounds of component I-a), I-b), I-c), I-d), I-e), I-f), I-g), I-h), I-i), I-j), I-k) or I-l), in particular the light stabilizer 1-a-1, 1-a-2, 1-b-1, 1-c-1, 1-c-2, 1-d-1, 1-d-2, 1-d-3, 1-e-1, 1-f-1, 1-g1, 1-g-2 or 1-k-1 listed on columns 64-72 of said U.S. Pat. No. 5,980,783.

The sterically hindered amine may also be one of the compounds described in EP 782994, for example compounds as described in claims 10 or 38 or in Examples 1-12 or D-1 to D-5 therein.

2.7. Sterically hindered amines substituted on the N-atom by a hydroxy-substituted alkoxy group, for example compounds as disclosed in U.S. Pat. No. 6,271,377 and U.S. application Ser. No. 09/794,710, filed Feb. 27, 2001, such as 1-(2-hydroxy-2-methylpropoxy)-4-octadecanoyl-oxy-2,2,6,6-tetramethylpiperidine, 1-(2-hydroxy-2-methylpropoxy)-4-hexadecanoyloxy-2,2,-6,6-tetramethylpiperidine, the reaction product of 1-oxyl-4-hydroxy-2,2,6,6-tetramethyl-piperidine with a carbon radical from t-amylalcohol, 1-(2-hydroxy-2-methylpropoxy)-4-hydroxy-2,2,6,6-tetramethylpiperidine, 1-(2-hydroxy-2-methylpropoxy)-4-oxo-2,2,6,6-tetrame-thylpiperidine, bis(1-(2-hydroxy-2-methylpropoxy)-2,2,6,6-tetramethylpiperidin-4-yl) sebacate, bis(1-(2-hydroxy-2-methylpropoxy)-2,2,6,6-tetramethylpiperidin-4-yl) adipate, bis(1-(2-hydroxy-2-methylpropoxy)-2,2,6,6-tetramethylpiperidin-4-yl) succinate, bis(1-(2-hydroxy-2-methylpropoxy)-2,2,6,6-tetramethylpiperidin-4-yl) glutarate and 2,4-bis{N-[1-(2-hydroxy-2-methylpropoxy)-2,2,6,6-tetramethylpiperidin-4-yl]-N-butylamino}-6-(2-hydroxyethylamino)-s-triazine.

2.8. Oxamides, for example 4,4′-dioctyloxyoxanilide, 2,2′-diethoxyoxanilide, 2,2′-dioctyloxy-5,5′-di-tert-butoxanilide, 2,2′-didodecyloxy-5,5′-di-tert-butoxanilide, 2-ethoxy-2′-ethyloxanilide, N,N′-bis(3-dimethylaminopropyl)oxamide, 2-ethoxy-5-tert-butyl-2′-ethoxanilide and its mixture with 2-ethoxy-2′-ethyl-5,4′-di-tert-butoxanilide, mixtures of o- and p-methoxy-disubstituted oxanilides and mixtures of o- and p-ethoxy-disubstituted oxanilides.

2.9. Tris-aryl-o-hydroxyphenyl-s-triazines, for example known commercial tris-aryl-o-hydroxyphenyl-s-triazines and triazines as disclosed in, WO 96/28431, EP 434608, EP 941989, GB 2,317,893, U.S. Pat. Nos. 3,843,371; 4,619,956; 4,740,542; 5,096,489; 5,106,891; 5,298,067; 5,300,414; 5,354,794; 5,461,151; 5,476,937; 5,489,503; 5,543,518; 5,556,973; 5,597,854; 5,681,955; 5,726,309; 5,942,626; 5,959,008; 5,998,116 and 6,013,704, and U.S. application Ser. No. 09/383,163, for example 4,6-bis-(2,4-dimethyl-phenyl)-2-(2-hydroxy-4-octyloxyphenyl)-s-triazine, Cyasorb® 1164, Cytec Corp, 4,6-bis-(2,4-dimethylphenyl)-2-(2,4-dihydroxyphenyl)-s-triazine, 2,4-bis(2,4-dihydroxyphenyl)-6-(4-chlorophenyl)-s-triazine, 2,4-bis[2-hydroxy-4-(2-hydroxyethoxy)phenyl]-6-(4-chlorophenyl)-s-triazine, 2,4-bis[2-hydroxy-4-(2-hydroxy-4-(2-hydroxyethoxy)phenyl]-6-(2,4-dimethylphenyl)-s-triazine, 2,4-bis[2-hydroxy-4-(2-hydroxyethoxy)phenyl]-6-(4-bromophenyl)-s-triazine, 2,4-bis-[2-hydroxy-4-(2-acetoxyethoxy)phenyl]-6-(4-chlorophenyl)-s-triazine, 2,4-bis(2,4-dihydroxyphenyl)-6-(2,4-dimethylphenyl)-s-triazine, 2,4-bis(4-biphenylyl)-6-(2-hydroxy-4-octyloxycarbo-nylethylideneoxyphenyl)-s-triazine, 2-phenyl-4-[2-hydroxy-4-(3-sec-butyloxy-2-hydroxypropyloxy)phenyl]-6-[2-hydroxy-4-(3-sec-amyloxy-2-hydroxypropyloxy)phenyl]-s-triazine, 2,4-bis-(2,4-dimethylphenyl)-6-[2-hydroxy-4-(3-benzyloxy-2-hydroxypropyloxy)phenyl]-s-triazine, 2,4-bis(2-hydroxy-4-n-butyloxyphenyl)-6-(2,4-di-n-butyloxyphenyl)-s-triazine, 2,4-bis(2,4-dimethylphenyl)-6-[2hydroxy-4-(3-nonyloxy*-2-hydroxypropyloxy)-5-α-cumylphenyl]-s-triazine (*denotes a mixture of octyloxy, nonyloxy and decyloxy groups), methylenebis-{2,4-bis(2,4-dimethylphenyl)-6-[2-hydroxy-4-(3-butyloxy-2-hydroxypropoxy)phenyl]-s-triazine}, methylene bridged dimer mixture bridged in the 3:5′, 5:5′ and 3:3′ positions in a 5:4:1 ratio, 2,4,6-tris-(2-hydroxy-4-isooctyloxycarbonylisopropylideneoxyphenyl)-s-triazine, 2,4-bis-(2,4-dimethylphenyl)-6-(2-hydroxy-4-hexyloxy-5-α-cumylphenyl)-s-triazine, 2-(2,4,6-trimethylphenyl)-4,6-bis[2-hydroxy-4-(3-butyloxy-2-hydroxypropyloxy)phenyl]-s-triazine, 2,4,6-tris[2-hydroxy-4-(3-sec-butyloxy-2-hydroxypropyloxy)phenyl]-s-triazine, mixture of 4,6-bis-(2,4-dimethylphenyl)-2-(2-hydroxy-4-(3-dodecyloxy-2-hydroxypropoxy)-phenyl)-s-triazine and 4,6-bis-(2,4-dimethyl-phenyl)-2-(2-hydroxy-4-(3-tridecyloxy-2-hydroxypropoxy)-phenyl)-s-triazine, Tinuvin® 400, Ciba Specialty Chemicals Corp., 4,6-bis-(2,4-dimethylphenyl)-2-(2-hydroxy-4-(3-(2-ethylhexyloxy)-2-hydroxypropoxy)-phenyl)-s-triazine and 4,6-diphenyl-2-(4-hexyloxy-2-hydroxyphenyl)-s-triazine.

3. Metal deactivators, for example N,N′-diphenyloxamide, N-salicylal-N′-salicyloyl hydrazine, N,N′-bis(salicyloyl) hydrazine, N,N′-bis(3,5-di-tert-butyl-4-hydroxyphenylpropionyl) hydrazine, 3-salicyloylamino-1,2,4-triazole, bis(benzylidene)oxalyl dihydrazide, oxanilide, isophthaloyl dihydrazide, sebacoyl bisphenylhydrazide, N,N′-diacetyladipoyl dihydrazide, N, N′-bis(salicyloyl)oxalyl dihydrazide, N,N′-bis(salicyloyl)thiopropionyl dihydrazide.

4. Phosphites and phosphonites, for example triphenyl phosphite, diphenyl alkyl phosphites, phenyl dialkyl phosphites, tris(nonylphenyl) phosphite, trilauryl phosphite, trioctadecyl phosphite, distearyl pentaerythritol diphosphite, tris(2,4-di-tert-butylphenyl) phosphite, diisodecyl pentaerythritol diphosphite, bis(2,4-di-tert-butylphenyl) pentaerythritol diphosphite, bis(2,6-di-tert-butyl-4-methylphenyl)-pentaerythritol diphosphite, diisodecyloxypentaerythritol diphosphite, bis(2,4-di-tert-butyl-6-methylphenyl)pentaerythritol diphosphite, bis(2,4,6-tris(tert-butylphenyl)pentaerythritol diphosphite, tristearyl sorbitol triphosphite, tetrakis(2,4-di-tert-butylphenyl) 4,4′-biphenylene diphosphonite, 6-isooctyloxy-2,4,8,10-tetra-tert-butyl-dibenzo[d,f][1,3,2]dioxaphosphepin, 6-fluoro-2,4,8, 1 0-tetra-tert-butyl-1 2-methyl-dibenzo[d,g]-[1,3,2]dioxaphosphocin, bis(2,4-di-tert-butyl-6-methylphenyl) methyl phosphite, bis(2,4-di- tert-butyl-6-methylphenyl) ethyl phosphite, 2,2′, 2″-nitrilo[triethyltris(3,3′,5,5′-tetra-tert-butyl-1,1′-biphenyl-2,2′-diyl)phosphite], 2-ethylhexyl(3,3′,5,5′-tetra-tert-butyl-1,1′-biphenyl-2,2′-di-yl)phosphite.

For example the following phosphites:

Tris(2,4-di-tert-butylphenyl) phosphite (Irgafos®168, Ciba Specialty Chemicals Corp.),

tris(nonylphenyl) phosphite,

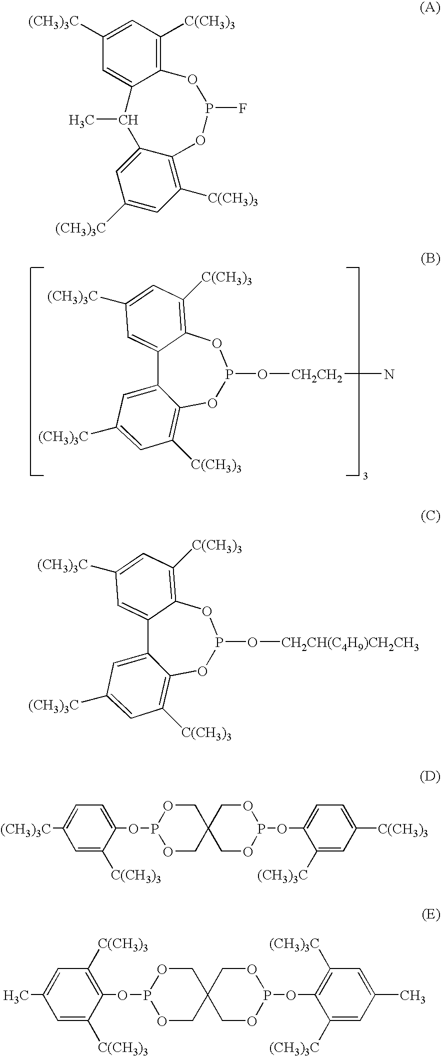

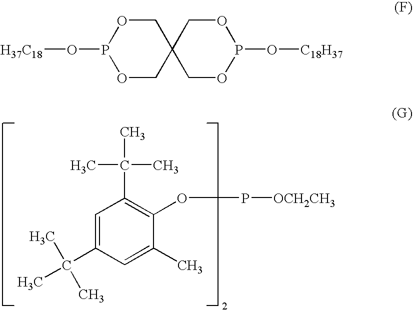

5. Hydroxylamines, for example N,N-dibenzylhydroxylamine, N,N-diethylhydroxylamine, N,N-dioctylhydroxylamine, N,N-dilaurylhydroxylamine, N,N-ditetradecylhydroxylamine, N,N-dihexadecylhydroxylamine, N,N-dioctadecylhydroxylamine, N-hexadecyl-N-octadecylhydroxylamine, N-heptadecyl-N-octadecylhydroxylamine, N-methyl-N-octadecylhydroxylamine and the N,N-dialkylhydroxylamine derived from hydrogenated tallow amine.

6. Nitrones, for example N-benzyl-α-phenylnitrone, N-ethyl-α-methylnitrone, N-octyl-α-heptylnitrone, N-lauryl-α-undecylnitrone, N-tetradecyl-α-tridcylnitrone, N-hexadecyl-α-penta-decylnitrone, N-octadecyl-α-heptadecylnitrone, N-hexadecyl-α-heptadecylnitrone, N-ocata-decyl-α-pentadecylnitrone, N-heptadecyl-α-heptadecylnitrone, N-octadecyl-α-hexadecyl-nitrone, N-methyl-α-heptadecylnitrone and the nitrone derived from N,N-dialkylhydroxylamine derived from hydrogenated tallow amine.

7. Amine oxides, for example amine oxide derivatives as disclosed in U.S. Pat. Nos. 5,844,029 and 5,880,191, didecyl methyl amine oxide, tridecyl amine oxide, tridodecyl amine oxide and trihexadecyl amine oxide.

8. Benzofuranones and indolinones, for example those disclosed in U.S. Pat. Nos. 4,325,863, 4,338,244, 5,175,312, 5,216,052, 5,252,643; DE-A-4316611; DE-A-4316622; DE-A-4316876; EP-A-0589839 or EP-A-0591102 or 3-[4-(2-acetoxyethoxy)phenyl]-5,7-di-tert-butyl-benzofuran-2-one, 5,7-di-tert-butyl-3-[4-(2-stearoyloxyethoxy)phenyl]benzofuran-2-one, 3,3′-bis[5,7-di-tert-butyl-3-(4-[2-hydroxyethoxy]phenyl)benzofuran-2-one], 5,7-di-tert-butyl-3-(4-ethoxyphenyl)benzofuran-2-one, 3-(4-acetoxy-3,5-dimethylphenyl)-5,7-di-tert-butyl-benzofuran-2-one, 3-(3,5-dimethyl-4-pivaloyloxyphenyl)-5,7-di-tert-butyl-benzofuran-2-one, 3-(3,4-dimethylphenyl)-5,7-di-tert-butyl-benzofuran-2-one, Irganox® HP-136, Ciba Specialty Chemicals Corp., and 3-(2,3-dimethylphenyl)-5,7-di-tert-butyl-benzofuran-2-one.

9. Thiosynergists, for example dilauryl thiodipropionate or distearyl thiodipropionate.

10. Peroxide scavengers, for example esters of β-thiodipropionic acid, for example the lauryl, stearyl, myristyl or tridecyl esters, mercaptobenzimidazole or the zinc salt of 2-mercapto-benzimidazole, zinc dibutyldithiocarbamate, dioctadecyl disulfide, pentaerythritol tetrakis(β-dodecylmercapto)propionate.

11. Polyamide stabilizers, for example copper salts in combination with iodides and/or phosphorus compounds and salts of divalent manganese, for example Cul.

12. Basic co-stabilizers, for example melamine, polyvinylpyrrolidone, dicyandiamide, triallyl cyanurate, urea derivatives, hydrazine derivatives, amines, polyamides, polyurethanes, alkali metal salts and alkaline earth metal salts of higher fatty acids, for example, calcium stearate, zinc stearate, magnesium behenate, magnesium stearate, sodium ricinoleate and potassium palmitate, antimony pyrocatecholate or zinc pyrocatecholate.

13. Nucleating agents, for example inorganic substances such as talcum, metal oxides such as titanium dioxide or magnesium oxide, phosphates, carbonates or sulfates of, for example, alkaline earth metals; organic compounds such as mono- or polycarboxylic acids and the salts thereof, e.g. 4-tert-butylbenzoic acid, adipic acid, diphenylacetic acid, sodium succinate or sodium benzoate; polymeric compounds such as ionic copolymers (ionomers).

14. Fillers and reinforcing agents, for example calcium carbonate, silicates, glass fibres, glass bulbs, asbestos, talc, kaolin, mica, barium sulfate, metal oxides and hydroxides, carbon black, graphite, wood flour and flours or fibers of other natural products, synthetic fibers.

15. Dispersing Agents, such as polyethylene oxide waxes or mineral oil.

16. Other additives, for example plasticizers, lubricants, emulsifiers, pigments, dyes, optical brighteners, rheology additives, catalysts, flow-control agents, slip agents, crosslinking agents, crosslinking boosters, halogen scavengers, smoke inhibitors, flameproofing agents, antistatic agents, clarifiers such as substituted and unsubstituted bisbenzylidene sorbitols, benzoxazinone UV absorbers such as 2,2′-p-phenylene-bis(3,1-benzoxazin-4-one), Cyasorb® 3638 (CAS# 18600-59-4), and blowing agents. The co-stabilizers, with the exception of the benzofuranones, are added for example in concentrations of about 0.01 to about 10%, relative to the total weight of the material to be stabilized.

The phenolic antioxidant of particular interest is selected from the group consisting of n-octadecyl 3,5-di-tert-butyl-4-hydroxyhydrocinnamate, neopentanetetrayl tetrakis(3,5-di-tert-butyl-4-hydroxyhydrocinammate), di-n-octadecyl 3,5-di-tert-butyl-4-hydroxybenzylphosphonate, 1,3,5-tris(3,5-di-tert-butyl-4-hydroxybenzyl)isocyanurate, thiodiethylene bis(3,5-di-tert-butyl-4-hydroxyhydrocinnamate), 1,3,5-trimethyl-2,4,6-tris(3,5-di-tert-butyl-4-hydroxybenzyl)benzene, 3,6-dibxaoctamethylene bis(3-methyl-5-tert-butyl-4-hydroxyhydrocinnamate), 2,6-di-tert-butyl-p-cresol, 2,2′-ethylidene-bis(4,6-di-tert-butylphenol), 1,3,5-tris(2,6-dimethyl-4-tert-butyl-3-hydroxybenzyl)isocyanurate, 1,1,3,-tris(2-methyl-4-hydroxy-5-tert-butylphenyl)butane, 1,3,5-tris[2-(3,5-di-tert-butyl-4-hydroxyhydrocinnamoyloxy)ethyl]isocyanurate, 3,5-di-(3,5-di-tert-butyl-4-hydroxybenzyl)mesitol, hexamethylene bis(3,5-di-tert-butyl-4-hydroxyhydrocinna-mate), 1-(3,5-di-tert-butyl-4-hydroxyanilino)-3,5-di(octylthio)-s-triazine, N,N′-hexamethylene-bis(3,5-di-tert-butyl-4-hydroxyhydrocinnamamide), calcium bis(ethyl 3,5-di-tert-butyl-4-hydroxybenzylphosphonate), ethylene bis[3,3-di(3-tert-butyl-4-hydroxyphenyl)butyrate], octyl 3,5-di-tert-butyl-4-hydroxybenzylmercaptoacetate, bis(3,5-di-tert-butyl-4-hydroxyhydrocinnamoyl)hydrazide, N,N′-bis[2-(3,5-di-tert-butyl-4-hydroxyhydrocinnamoyloxy)-ethyl]-oxamide, 2,4-bis(octylthiomethyl)-6-methylphenol, and 2,4-bis(octylthiomethyl)-6-tert-butylphenol.

The phenolic antioxidant is for example neopentanetetrayl tetrakis(3,5-di-tert-butyl-4-hydroxyhydrocinnamate), n-octadecyl 3,5-di-tert-butyl-4-hydroxyhydrocinnamate, 1,3,5-tri-methyl-2,4,6-tris(3,5-di-tert-butyl-4-hydroxybenzyl)benzene, 1,3,5-tris(3,5-di-tert-butyl-4-hydroxybenzyl)isocyanurate, 2,6-di-tert-butyl-p-cresol, 2,2′-ethylidene-bis(4,6-di-tert-butylphenol), 2,4-bis(octylthiomethyl)-6-methylphenol or 2,4-bis(octylthiomethyl)-6-tert-butylphenol.

The hindered amine compound of particular interest is selected from the group consisting of bis(2,2,6,6-tetramethylpiperidin-4-yl) sebacate, bis(1,2,2,6,6-pentamethylpiperidin-4-yl) sebacate, di(1,2,2,6,6-pentamethylpiperidin-4-yl) (3,5-di-tert-butyl-4-hydroxybenzyl)butylmalonate, 4-benzoyl-2,2,6,6-tetramethylpiperidine, 4-stearyloxy-2,2,6,6-tetramethylpiperidine, 3-n-octyl-7,7,9,9-tetramethyl-1,3,8-triaza-spiro[4.5]decane-2,4-dione, tris(2,2,6,6-tetramethylpiperidin-4-yl) nitrilotriacetate, 1,2-bis(2,2,6,6-tetramethyl-3-oxopiperazin-4-yl)ethane, 2,2,4,4-tetramethyl-7-oxa-3,20-diaza-21-oxodispiro[5.1.11.2] heneicosane, polycondensation product of 2,4-dichloro-6-tert-octylamino-s-triazine and 4,4′-hexamethylenebis(amino-2,2,6,6-tetramethylpiperidine), polycondensation product of 1-(2-hydroxyethyl)-2,2,6,6-tetramethyl-4-hydroxypiperidine and succinic acid, polycondensation product of 4,4′-hexamethylenebis-(amino-2,2,6,6-tetramethylpiperidine) and 1,2-dibromoethane, tetrakis(2,2,6,6-tetramethylpiperidin-4-yl) 1,2,3,4-butanetetracarboxylate, tetrakis-(1,2,2,6,6-pentamethylpiperidin-4-yl) 1,2,3,4-butanetetracarboxylate, polycondensation product of 2,4-dichloro-6-morpholino-s-triazine and 4,4′-hexamethylenebis(amino-2,2,6,6-tetramethylpiperidine), N,N′,N″,N′″-tetrakis[(4,6-bis(butyl-1,2,2,6,6-pentamethylpiperidin-4-yl)-amino-s-triazin-2-yl]-1,10-diamino-4,7-diazadecane, mixed [2,2,6,6-tetramethylpiperidin-4-yl-β, β,β′,β′-tetramethyl-3,9-(2,4,8 ,10-tetraoxaspiro[5.5]-undecane) diethyl] 1,2,3,4-butanetetracarboxylate, mixed [1 ,2,2,6,6-pentamethylpiperidin-4-yl/β,β,β′,β′-tetramethyl-3,9-(2,4,8,10-tetraoxaspiro[5. 5]undecane)diethyl]1,2,3,4-butanetetracarboxylate, octamethylene bis(2,2,6,6-tetramethylpiperidin-4-carboxylate), 4,4′-ethylenebis(2,2,6,6-tetramethylpiperazin-3-one), N-2,2,6,6-tetramethylpiperidin-4-yl-n-dodecylsuccinimide, N-1,2,2,6,6-pentamethylpiperidin-4-yl-n-dodecylsuccinimide, N-1-acetyl-2,2,6,6-tetramethylpiperidin-4-yl-dodecylsuccinimide, 1-acetyl3-dodecyl-7,7,9,9-tetramethyl-1,3,8-triazaspiro[4.5]decane-2,4-dione, di-(1-octyloxy-2,2,6,6-tetramethylpiperidin-4-yl) sebacate, di-(1-cyclohexyloxy-2,2,6,6-tetramethylpiperidin-4-yl) succinate, 1-octyloxy-2,2,6,6-tetramethyl-4-hydroxy-piperidine, poly-{[6-tert-octylamino-s-triazin-2,4-diyl][2-(1-cyclohexyloxy-2,2,6,6-tetramethylpiperidin-4-yl)iminohexamethylene-[4-(1-cyclohexyloxy-2,2,6,6-tetramethylpiperidin-4-yl)imino], 2,4,6-tris[N-(1-cyclohexyloxy-2,2,6,6-tetramethylpiperidin-4-yl)-n-butylamino]-s-triazine, 2-(2-hydroxyethyl)-amino-4,6-bis[N-(1-cyclohexyloxy-2,2,6,6-tetramethylpiperidin-4-yl)-n-butylamino]-s-triazine, 1,2-bis(3,3,5,5-tetramethylpiperazin-2-on-1-yl)ethane, 1,3,5-tris{N-cyclohexyl-N-[2-(3,3,5,5-tetramethylpiperazin-2-on-1-yl)ethyl]amino)-s-triazine, 1,3,5-tris{N-cyclohexyl-N-[2-(3,3,4,5,5-pentaamethylpiperazin-2-on-1-yl)ethyl]amino}-s-triazine, reaction of 2-4 equivalents of 2,4-bis[(1-cyclohexyloxy-2,2,6,6-tetramethylpiperidin-4-yl)butylamino]-6-chloro-s-triazine with 1 equivalent of N,N′-bis(3-aminopropyl)ethylenediamine, bis[1-(2-hydroxy-2-methylpropoxy)-2,2,6,6-tetramethylpiperidin-4-yl] sebacate, mixture of bis[1-(2-hydroxy-2-methylpropoxy)-2,2,6,6-tetramethylpiperidin-4-yl] glutarate and bis[1-(2-hydroxy-2-methylpropoxy)-2,2,6,6-tetramethylpiperidin-4-yl] adipate, 4-hydroxy-1-(2-hydroxy-2-methylpropoxy)-2,2,6,6-tetramethylpiperidine and 4-octadecyloxy-1-(2-hydroxy-2-methylpropoxy)-2,2,6,6-tetramethylpiperidine.

The hindered amine compound is for example bis(2,2,6,6-tetramethylpiperldin-4-yl) sebacate, bis(1,2,2,6,6-pentamethylpiperidin-4-yl) sebacate, di(1,2,2,6,6-pentamethylpiperidin-4-yl) (3,5-di-tert-butyl-4-hydroxybenzyl)butylmalonate, the polycondensation product of 1-(2-hydroxyethyl)-2,2,6,6-tetramethyl-4-hydroxypiperidine and succinic acid, the polycondensation product of 2,4-dichloro-6-tert-octylamino-s-triazine and 4,4′-hexamethylenebis(amino-2,2,6,6-tetramethylpiperidine), N,N′,N″,N′″-tetrakis[(4,6-bis(butyl-(1,2,2,6,6-pentamethylpiperidin-4-yl)amino)-s-triazine-2-yl]-1,1 0-diamino-4,7-diazadecane. di-(1-octyloxy-2,2,6,6-tetramethylpiperidin-4-yl) sebacate, di-(1-cyclohexyloxy-2,2,6,6-tetramethylpiperidin-4-yl) succinate, 1-octyloxy-2,2,6,6-tetramethyl-4-hydroxy-piperidine, poly-{[6-tert-octylamino-s-triazin-2,4-diyl][2-(1-cyclohexyloxy-2,2,6,6-tetramethylpiperidin-4-yl)imino-hexamethylene-[4-(1-cyclohexyloxy-2,2,6,6-tetramethylpiperidin-4-yl)imino], 2,4,6-tris[N-(1-cyclohexyloxy-2,2,6,6-tetramethylpiperidin-4-yl)-n-butylamino]-s-triazine, 2-(2-hydroxyethyl)amino-4,6-bis[N-(1-cyclohexyloxy-2,2,6,6-tetramethylpiperidin-4-yl)-n-butylamino]-s-triazine, 1,2-bis(3,3,5,5-tetramethylpiperazin-2-on-1-yl)ethane, 1,3,5-tris{N-cyclohexyl-N-[2-(3,3,5,5-tetramethylpiperazin-2-on-1-yl)ethyl]amino)-s-triazine, 1,3,5-tris{N-cyclohexyl-N-[2-(3,3,4,5,5-pentaamethylpiperazin-2-on-1-yl)ethyl]amino)-s-triazine, reaction of 2-4 equivalents of 2,4-bis[(1-cyclohexyloxy-2,2,6,6-tetramethylpiperidin-4-yl)butylamino]-6-chloro-s-triazine with 1 equivalent of N,N′-bis(3-aminopropyl)ethylenediamine, bis[1-(2-hydroxy-2-methylpropoxy)-2,2,6,6-tetramethylpiperidin-4-yl] sebacate, mixture of bis[1-(2-hydroxy-2-methylpropoxy)-2,2,6,6-tetramethylpiperidin-4-yl] glutarate and bis[1-(2-hydroxy-2-methylpropoxy)-2,2,6,6-tetramethylpiperidin-4-yl] adipate, 4-hydroxy-1-(2-hydroxy-2-methylpropoxy)-2,2,6,6-tetramethylpiperidine or 4-octadecyloxy-1-(2-hydroxy-2-methylpropoxy)-2,2,6,6-tetramethylpiperidine.

The instant compositions may additionally contain another UV absorber selected from the group consisting of benzotriazoles, s-triazines, oxanilides, hydroxybenzophenones, benzoates, α-cyanoacrylates, malonates, salicylates, and benzoxazinones 2,2′-p-phenylene-bis(3,1-benzoxazin-4-one), Cyasorb® 3638 (CAS# 18600-59-4), Cytec Corp.

Of particular interest as optional co-additives in the present compositions are those selected from the classes of known hydroxyphenylbenzotriazole UV absorbers and hindered amine compounds.

The following examples are for illustrative purposes. The following additives are used in the working Examples:
Tinuvin® 327, 5-chloro-2-(2-hydroxy-3,5-di-tert-butylphenyl)-2H-benzotriazole, Chimassorb® 81, 2-hydroxy-4-octyloxybenzophenone, and
Tinuvin® 928, 3-α-cumyl-2-hydroxy-5-t-octylphenyl-2H-benzotriazole and
(a) 3-(5-trifluoromethyl-2H-benzotriazol-2-yl)-5-tert-butyl-4-hydroxyhydrocinnamic acid;
(b) methyl 3-(5-trifluoromethyl-2H-benzotriazol-2-yl)-5-tert-butyl-4-hydroxyhydrocinnamate;
(c) isooctyl 3-(5-trifluoromethyl-2H-benzotriazol-2-yl)-5-tert-butyl-4-hydroxyhydrocinnamate;
(d) 5-trifluoromethyl-2-[2-hydroxy-5-(3-hydroxypropyl)phenyl]-2H-benzotriazole;
(e) 5-trifluoromethyl-2-[2-hydroxy-3-α-cumyl-5-(2-hydroxyethyl)phenyl]-2H-benzotriazole;
(f) 5-trifluoromethyl-2-[2-hydroxy-3-α-cumyl-5-(3-hydroxypropyl)phenyl]-2H-benzotrialazole;
(g) 5-trifluoromethyl-2-[2-hydroxy-3-tert-butyl-5-(3-hydroxypropyl)phenyl)-2H-benzotriazole;
(h) 5-trifluoromethyl-2-[2-hydroxy-3-tert-butyl-5-(2-hydroxyethyl)phenyl]-2H-benzotriazole;
(i) 5-trifluoromethyl-2-[2-hydroxy-5-(2-hydroxyethyl)phenyl]-2H-benzotriazole;
(j)isooctyl 3-(5-chloro-2H-benzotriazol-2-yl)-5-tert-butyl-4-hydroxyhydrocinnamate;
(k) isooctyl 3-(5-phenylsulfonyl-2H-benzotriazol-2-yl)-5-tert-butyl-4-hydroxyhydrocinnamate;
(I) methyl 3-(5-phenylsulfonyl-2H-benzotriazol-2-yl)-5-tert-butyl-4-hydroxyhydrocinnamate;
(m) 3-(5-phenylsulfonyl-2H-benzotriazol-2-yl)-5-tert-butyl-4-hydroxyhydrocinnamic acid;
(n) 3-(5-trifluoromethyl-2H-benzotriazol-2-yl)-α-cumyl-4-hydroxyhydrocinnamic acid;
(o) isooctyl 3-(5-chloro-2H-benzotriazol-2-yl)-5-tert-butyl-4-hydroxyhydrocinnamate;
(p) methyl 3-(5-chloro-2H-benzotriazol-2-yl)-5-tert-butyl-4-hydroxyhydrocinnamate;
(q) 3-(5-chloro-2H-benzotriazol-2-yl)-5-tert-butyl-4-hydroxyhydrocinnamic acid;
(r) methyl 3-(5-fluoro-2H-benzotriazol-2-yl)-5-tert-butyl-4-hydroxyhydrocinnamate;
(s) 5-trifluoromethyl-2-[2-hydroxy-3-tert-butyl-4-(2-hydroxyethoxy)phenyl]-2H-benzotriazole;
(t) 5-chloro-2-[2-hydroxy-3-tert-butyl-4-(2-hydroxyethoxy)phenyl]-2H-benzotriazole and
(u) 5-(methoxycarbonylmethylsulfonyl)-3,5-di-tert-butyl-2-hydroxyphenyl-2H-benzotriazole.

Tinuvin® 327, Tinuvin® 109, Chimassorb® 81 and Tinuvin® 928 are available from Ciba Specialty Chemicals.

### EXAMPLE 1

### Pet Bottles

PET concentrates (10% by weight) of the UV-absorbers of the table below are prepared using Eastapak 9921W PET, on a 27 mm twin screw extruder at an operating temperature at die of 275° C. The hydroxyphenylbenzotriazoles are reacted into the PET under the extrusion conditions.

The concentrates are letdown with base resin to the final additive loading indicated in the table below. PET is dried in vacuo for at least 4 hours at 240° F. prior to preform molding. Preforms are molded on a unit cavity Arburg press using the minimum injection temperature and back pressure necessary to obtain parts free of haze an crystallinity. Bottle blow molding is conducted using a Sidel SBO 2/3 blow molding machine, using preforms described above. Bottle wall thickness of 0.015-0.016 inches is achieved.

| Formulation | UV Absorber | weight % on resin |
|---|---|---|
| 1 (control) | none | |
| 2 (control) | Tinuvin ® 327 | 0.3 |
| 3 (control) | Chimassorb ® 81 | 0.3 |
| 4-24 | UVA (a)-(u) | 0.3 |
| 25-45 | 1:1 mix of Tinuvin ® 928 | 0.3 |
| | and UVA (a)-(u) | |

The molded bottles represent 16-20 oz. water or soda type PET bottles and 200 mL cough syrup type PET bottles.

### EXAMPLE 2

### Percent Transmission

Percent transmission data is obtained for 200 mL cough syrup bottles prepared according to Example 1. Percent transmission is measured for bottles prepared from formulations 1-45.

Essentially all the damaging UV light is screened with the bottles which have incorporated therein via condensation reaction a small amount of UV absorber (a) of the present invention.

For the following Examples the exposure conditions are as follows:

Samples are exposed under a bank of six (6) cool white fluorescent lamps (40 watts) or under a bank of six (6) UV lamps having a wavelength of 368 nm with the test samples being twelve (12) inches (30.48 cm) below the lamps.

Dye color fade (or color change) is measured by a Macbeth ColorEye Spectrophotometer with a 6 inch integrating sphere. The conditions are: 10 degree observer; D65 illuminant and 8 degree viewing angle.

Initial color measurements are taken using the above parameters. The L, a and b values are calculated using the CIE system from the reflectance values. YI is calculated from the L, a and b values. Subsequent measurements are taken at specified intervals. Delta L, a, b and YI values are simply the difference between the initial values and the values at each interval. Delta (Δ) E is calculated as follows: [(Δ L)²+(Δ a)²+(Δ b)²]^{1/2}=Δ E

A low Δ E indicates less change in color and is highly desirable. Example 2-45 show lower Δ E values as compared to the control sample 1.

### EXAMPLE 3

### Color Stabilization of Commercial Mouthwash

The commercial mouthwash is Listerine® Tartar Control antiseptic mouthwash, U.S. Pat. No. 5,891,422, which contains F & DC Blue #1 (Warner-Lambert Consumer Healthcare). The color change of the mouthwash contained in 16 oz. PET bottles prepared according to Example 1 is measured after exposure to fluorescent light. The bottles are filled to 3/4 full (500 g of mouthwash) and the lids are securely fastened. The bottles are exposed as above. Delta E is measured for bottles prepared from formulations 1-45.

These data indicate that PET bottles which have incorporated therein via condensation reaction a UV absorber of the present invention, protects the contents from unwanted discoloration far better than a conventional UV absorber.

### EXAMPLE 4

### Color Stabilization of Commercial Mouthwash

The commercial mouthwash is Listerine® Tartar Control antiseptic mouthwash, U.S. Pat. No. 5,891,422, which contains F & DC Blue #1 (Warner-Lambert Consumer Healthcare). The color change of the mouthwash contained in 16 oz. PET bottles prepared according to Example 1 is measured after exposure to ultraviolet (UV) light. The bottles are filled to 3/4 full (500 g of mouthwash) and the lids are securely fastened. The bottles are exposed as above. Delta E is measured for bottles prepared from formulations 1-45.

These data indicate that PET bottles which have incorporated therein a UV absorber of the present invention via condensation reaction, protects the contents from unwanted discoloration far better than a conventional UV absorber.

### EXAMPLE 5

### Color Stabilization of an Aqueous Dye Solution

The commercial dye is Fast Green FCF (C.l. 42053; Food Green 3), purchased from Sigma-Aldrich. The color change of the solutions in 16 oz. PET bottles prepared according to Example 1 is measured after exposure to fluorescent light. The bottles are filled to 3/4 full with 500 g of a 2 ppm aqueous dye solution and the lids are securely fastened. The bottles are exposed as above. Delta E is measured for bottles prepared from formulations 1-45.

These data indicate that PET bottles which have incorporated therein a UV absorber of the present invention via condensation reaction, protects the contents from unwanted discoloration far better than a conventional UV absorber.

### EXAMPLE 6

### Color Stabilization of an Aqueous Dye Solution

The commercial dye is Fast Green FCF (C.l. 42053; Food Green 3), purchased from Sigma-Aldrich. The color change of the solutions in 16 oz. PET bottles prepared according to Example 1 is measured after exposure to ultraviolet (UV) light. The bottles are filled to 3/4 full with 500 g of a 2 ppm aqueous dye solution and the lids are securely fastened. The bottles are exposed as above. Delta E is measured for bottles prepared from formulations 1-45.

These data indicate that PET bottles which have incorporated therein a UV absorber of the present invention via condensation reaction, protects the contents from unwanted discoloration far better than a conventional UV absorber.

### EXAMPLE 7

### Color Stabilization of a Commercial Shampoo

The commercial shampoo is Suave® Strawberry Shampoo which contains D&C Orange #4 (C.l. 15510) and D&C Red #33 (C.l. 17200). The color change of the shampoo in 16 oz. PET bottles prepared according to Example 1 is measured after exposure to fluorescent light. The bottles are filled to 34 full with 500 g of the shampoo and the lids are securely fastened. The bottles are exposed as above. Delta E is measured for bottles prepared from formulations 1-45.

These data indicate that PET bottles which have incorporated therein via condensation reaction a UV absorber of the present invention, protects the contents from unwanted discoloration far better than a conventional UV absorber.

### EXAMPLE 8

### Color Stabilization of a Commercial Shampoo

The commercial shampoo is Suave® Strawberry Shampoo which contains D&C Orange #4 (C.l. 15510) and D&C Red #33 (C.l. 17200). The color change of the shampoo in 16 oz. PET bottles prepared according to Example 1 is measured after exposure to ultraviolet (UV) light. The bottles are filled to 3/4 full with 500 g of the shampoo and the lids are securely fastened. The bottles are exposed as above. Delta E is measured for bottles prepared from formulations 1-45.

These data indicate that PET bottles which have incorporated therein via condensation reaction a UV absorber of the present invention, protects the contents from unwanted discoloration far better than a conventional UV absorber.

### EXAMPLE 9

To formulations 1-45, each of the following additional stabilizers are also added:
5-chloro-2-(2-hydroxy-3-α-cumyl-5-tert-octylphenyl)-2H-benzotriazole;
2-(2-hydroxy-3-α-cumyl-5-tert-octylphenyl)-2H-benzotriazole;
5-trifluoromethyl-2-(2-hydroxy-3-α-cumyl-5-tert-octylphenyl)-2H-benzotriazole;
5-trifluoromethyl-2-(2-hydroxy-5-tert-octylphenyl)-2H-benzotriazole;
5-trifluoromethyl-2-(2-hydroxy-3,5-di-tert-octylphenyl)-2H-benzotriazole;
5-butylsulfonyl-2-(2-hydroxy-3-α-cumyl-5-tert-octylphenyl)-2H-benzotriazole;
5-trifluoromethyl-2-(2-hydroxy-3-α-cumyl-5-tert-butylphenyl)-2H-benzotriazole;
5-trifluoromethyl-2-(2-hydroxy-3,5-di-tert-butylphenyl)-2H-benzotriazole;
5-trifluoromethyl-2-(2-hydroxy-3,5-di-α-cumylphenyl)-2H-benzotriazole;
5-butylsulfonyl-2-(2-hydroxy-3,5-di-tert-butylphenyl)-2H-benzotriazole;
5-phenylsulfonyl-2-(2-hydroxy-3,5-di-tert-butylphenyl)-2H-benzotriazole;
5-chloro-2-(2-hydroxy-3,5-di-tert-butylphenyl)-2H-benzotriazole;
2-hydroxy-4-octyloxybenzophenone;
3-α-cumyl-2-hydroxy-5-t-octylphenyl-2H-benzotriazole;
2-(2-hydroxy-3,5-di-α-cumyl)-2H-benzotriazole;
5-chloro-2-(2-hydroxy-3-tert-butyl-5-methylphenyl)-2H-benzotriazole and 4,6-diphenyl-2-(4-hexyloxy-2-hydroxyphenyl)-s-triazine.

Each of the stabilized resin compositions are then blow or injection molded into a PET bottle having incorporated therein each of the UV absorbers. The PET bottles are especially effective at protecting the contents therein from UV radiation, allowing a longer shelf life of the product.

### EXAMPLE 10

To separate poly(ethylene terephthalate), PET, resin formulations are added 0.5% by weight of each of the s-triazine stabilizers (1)-(15) described in the specification.

Each of the stabilized resin compositions are then blow or injection molded into a PET bottle having incorporated therein each of the UV absorbers. The PET bottles are especially effective at protecting the contents therein from UV radiation, allowing a longer shelf life of the product.

### EXAMPLE 11

A multi-layer bottle is prepared wherein the exterior layer and the innermost layer contacting the contents are composed of PET and which also comprises a barrier layer. When one or more of the reactable benzotriazoles (a)-(u) or s-triazines (1)-(15) of the present invention are incorporated via condensation reaction into any of the PET layers at 0.5% by weight based on the weight of the resin, the contents of the bottle are effectively protected from UV radiation.

### EXAMPLE 12 AND COMPARATIVE EXAMPLES C1 AND C2

A) Analytical Procedures:

Intrinsic Viscosity (I.V.):

1 g polymer is dissolved in 100 g of a mixture of phenol/di-chloro-benzene (1/1). The viscosity of this solution is measured at 30° C. in an Ubelode-viscosimeter and recalculated to the intrinsic viscosity.

Color:

Color (b value of the Yellowness Index) is measured according to ASTM D1925 (DIN 5033). Following instrument is used: Minolta Spektrophotometer C M-3600 d

Extraction:

1 g PET powder is stirred at ambient temperature for 72 h in 100 g dichloromethane, which is a good solvent for the added UV-absorbers but a poor solvent for PET. The remaining PET is filtered, dried and 0.1% dissolved in hexafluoroisopropanol.

UV-Spectrum:

The PET-substance is milled to a fine powder, which is dissolved in hexafluoroisoproanol with a concentration of 0.1% (wt/volume). The UV-Spectra are measured between 190 and 600 nm relative to the pure solvent with a Lambda 2 spectrometer, Perkin Elmer. The UV-absorption coefficient is calculated at the corresponding peak maximum by dividing the absorption value by the concentration (unit mg/ml)

B) Pet Synthesis:

### COMPARATIVE EXAMPLE C1

1,654 g ethylene glycol, 3,322.6 g terephthalic acid, 83.1 g isophthalic acid and 1.36 g antimony trioxide are mixed within a metal container. The mixture is transferred into a 101 reactor (stainless steel) fitted with stirrer, refluxing unit and an outlet-die at the bottom of the reactor. The reactor can be either pressurized with nitrogen up to 6 bars or operated under vacuum down to 1 mbar. The monomer mixture is heated from room temperature to 250° C. within 30 mins. During heating phase pressure is increased up to 4 bars. A water/ethylene glycol mixture is distilled off for 3.5 h. Temperature is increased consecutively to 280° C. Within next 5 h pressure is continuously reduced to further distill off water and ethylene glycol. Then the polyester product is extruded through the bottom die, cooled to room temperature in a water bath and pelletized to yield clear PET granules.

Typically, by this procedure, a PET is synthesized with following properties:

I.V.: 0.75 dl/g;

Color: b=4

UV-absorption coefficient: there is no absorption above 320 nm

### COMPARATIVE EXAMPLE C2

The general procedure, as described in the comparative example C1, is repeated with the only difference that 11.93 g (24.54 mmol) Tinuvin® 327 is added.

Tinuvin® 327:

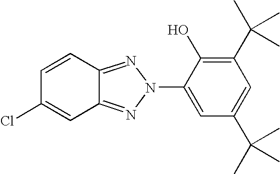

A PET is synthesized with following characteristics:

I.V.: 0.45 dl/g;

Color: b=13

UV absorption coefficient before extraction: 0.007 at 350 nm

UV-absorption coefficient after extraction: there is no significant UV-absorption above 325 nm

Explanation:

Tinuvin® 327 is not bound into the PET chain, which is proven by extraction (no significant UV-absorption above 325 nm after extraction)

The general procedure, as described in the comparative example C1, is repeated with the only difference that Tinuvin® 109 is added.

| | | | | UV absorption | UV absorption |
|---|---|---|---|---|---|
| | | | | coefficient | coefficient |
| Ex. | | I.V. | Pellet color | before | after |
| 12 | Additive | dl/g | b-value | extraction | extraction |
| | 8.79g (24.54 mmol) | 0.58 | 21 | 0.08 at 350 nm | 0.07 at 350 nm |
| | Tinuvin ® 109 | | | | |
| | 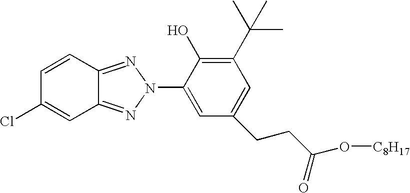 | | | | |

Explanation:

Tinuvin® 109 is bonded into the PET-chain, which is proven by the similar UV absorption coefficients before and after extraction.

### EXAMPLE 13

Experimental.

Predried PET (M&G Cleartuf AQUA) is physically blended with a UV-absorber at a prescribed weight percentage, thoroughly mixed, then fed to a 27 mm Leistritz co-rotating intermeshing twin screw extruder operated at an average setpoint temperature of 250° C. The extruder is equipped with a monolayer five inch (12,7 cm) sheet die. The extrusion screw speed, slit dimension of the die, and speed of chiller rolls is adjusted to achieve a 9 mil (229 micron) thick film in each formulation.

Samples of each film are cut for measurement of the UV light transmission and film color. The UV light transmission spectra are collected on a Perkin Elmer UVNIS-01 model Lambda 2, scan speed 240 nm/min. Color of the PET films is measured on a DCI SF-600 spectrophotometer, illuminant d65, 10 degrees in transmittance mode.

| | | % UV light | | | | |
|---|---|---|---|---|---|---|
| | Weight | transmission at | | | | |
| | Percent | wavelength | | PET film color | | |
| additive | In PET | 375 nm | 390 nm | L* | a* | b* |
| neat PET | 0 | 100 | 100 | 97.1 | −0.2 | 2.2 |
| “Tinuvin ® 109” | 0.20 | 19.1 | 31.6 | 96.8 | −0.4 | 2.5 |
| “Tinuvin ® 109” | 0.30 | 10.8 | 20.9 | 97.5 | −0.4 | 2.6 |
| “Tinuvin ® 109” | 0.40 | 4.8 | 11.5 | 97.3 | −0.5 | 2.7 |
| Heatwave ® PET CF746 | 0 | 64.6 | 74.4 | 97.0 | −0.2 | 2.3 |

The PET films containing the compounds of the invention demonstrate superior light blocking capability at and below 390 nm, in comparison to a state of the art comparative Heatwave CF746 polyester containing a UV-blocking technology as described by Eastman. The PET films provide acceptably low color compared to a standard unstabilized PET and the competitive Heatwave CF746, with the b* yellowness axis values all between 2 and 3 measured units.

### EXAMPLE 14

### Use of Tinuvin® 109 in the Synthesis of Polycarbonates

A) Analytical Procedures

Gel permeation chromatography:

Polymers are characterized by gel-permeation-chromatography (GPC), with a Hewlett Packard HP 1090 LC, column PSS 1, length 60 cm, elution with tetrahydrofurane (THF), rate 1 ml/min, concentration 10 mg polymer in 1 ml THF, Calibration with styrene. Polydispersity is calculated from Mn (g/mol) and Mw (in g/mol) as PD=Mw/Mn.

UV-Spectrum:

The PC-substance is milled to a fine powder, which is dissolved in dichloromethane with a concentration of 0.1% (wt/volume). The UV-Spectra are measured in Lambda 2 Perkin Elmer between 190 and 600 nm relative to the pure solvent. The UV-absorption coefficient of the most red-shifted absorption band is reported and calculated at the corresponding peak maximum by dividing the absorption value by the concentration (unit mg/ml).

B) Polycarbonate (PC) Synthesis:

### COMPARATIVE EXAMPLE C3

17.2 g bisphenol A, 16.1 g diphenylcarbonate and 0.187 g dibutyltinoxide is mixed in a 100 ml glass flask, fitted with stirrer and distillation unit. The mixture is heated within 1 h to 190° C., additional 5 h at 190° C. Within the next 3 h the pressure is continuously reduced down to 5 mbar and temperature consecutively increased up to 250° C. Progress of polycondensation is monitored by distilling-off phenol.

The raw product is completely dissolved in dichloromethane and precipitated in methanol. This procedure ensures that low molecular weight ingredients, such as non-bound UV-absorbers are removed.

Typically, by this procedure, a PC is synthesized with following properties:

Mn: 5,300 g/mol; Mw: 9,600 g/mol

UV-absorption coefficient: there is no absorption above 300 nm

### COMPARATIVE EXAMPLE C4

The general procedure, as described in the comparative example C3, is repeated with the only difference that 0,068 g Tinuvin® 327 is added.

Tinuvin® 327:

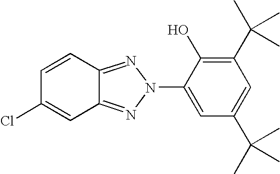

Hereby, a PC is synthesized with following characteristics:

Mn: 1,700 g/mol; Mw: 3,500 g/mol

UV-absorption coefficient: there is only a very low absorption coefficient above 300 nm.

Explanation:

Tinuvin® 327 is not bound into the PC chain, which is proven by the UV-absorption spectra of the precipitated PC

The general procedure, as described in the comparative example C3, is repeated with the only difference that Tinuvin® 109 is added.

| Ex. | | Mn | Mw | UV absorption |
|---|---|---|---|---|
| No. | Additive | [g/mol] | [g/mol] | coefficient |
| 14 | 0.070 g Tinuvin ® 109 | 1,700 | 2,400 | 0.105 at 355 nm |
| | 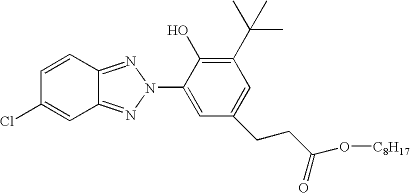 | | | |

Explanation:

Tinuvin® 109 is bonded into the PC-chain, which is proven by the UV absorption coefficients of the precipitated PC.

1. A method of protecting contents against the deleterious effects of ultraviolet radiation,
which method comprises storing the contents in a clear or lightly colored plastic container or film,
which container or film comprises
(a) a polymer component able to undergo a condensation reaction and
(b) an effective stabilizing amount of one or more UV absorbing moieties,
wherein said moieties are permanently and covalently bonded to the polymer component and are derived, via condensation, from UV absorbers selected from the group consisting of the durable hydroxyphenylbenzotriazole UV absorbers.

2. A method according to claim 1 wherein the hydroxyphenylbenzotriazole UV absorbers are of formula (I), (II) or (III) 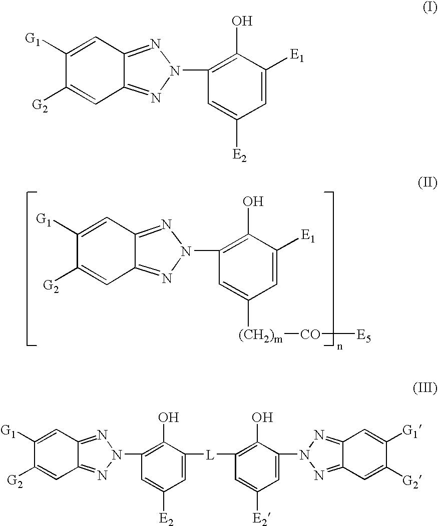
wherein
G₁ and G₁′ are independently hydrogen or halogen,
G₂ and G₂′ are independently halogen, nitro, cyano, perfluoroalkyl of 1 to 12 carbon atoms, —COOG₃, —P(O)(C₆H₅)₂, —CO-G₃, —CO—NH-G₃, —CO—N(G₃)₂, —N(G₃)-CO-G₃, E₃S—, E₃SO— or E₃SO₂—; or one of G₂ and G₂′ is also hydrogen,
G₃ is hydrogen, straight or branched chain alkyl of 1 to 24 carbon atoms, straight or branched chain alkenyl of 2 to 18 carbon atoms, cycloalkyl of 5 to 12 carbon atoms, phenylalkyl of 7 to 15 carbon atoms, phenyl, or said phenyl or said phenylalkyl substituted on the phenyl ring by 1 to 4 alkyl of 1 to 4 carbon atoms,
E₁ is hydrogen, straight or branched chain alkyl of 1 to 24 carbon atoms, straight or branched chain alkenyl of 2 to 24 carbon atoms, cycloalkyl of 5 to 12 carbon atoms, phenylalkyl of 7 to 15 carbon atoms, phenyl, or said phenyl or said phenylalkyl substituted on the phenyl ring by 1 to 4 alkyl of 1 to 4 carbon atoms; or E₁ is alkyl of 1 to 24 carbon atoms substituted by one or two hydroxy groups,
when E₁ is phenylalkyl of 7 to 15 carbon atoms or phenyl, or said phenyl or said phenylalkyl substituted on the phenyl ring by 1 to 4 alkyl of 1 to 4 carbon atoms, G₂ may also be hydrogen,
E₂ is straight or branched chain alkyl of 1 to 24 carbon atoms or straight or branched chain alkenyl of 2 to 18 carbon atoms, each substituted by one or more —OH, —OCOE₁₁, —NCO,
—NH₂, —NHCOE₁₁, —NHE₄ or glycidyloxy groups, or by mixtures thereof; or said alkyl or said alkenyl interrupted by one or more —O—, —NH— or —NE₄- groups or by mixtures thereof, where E₄ is straight or branched chain alkyl of 1 to 24 carbon atoms,
E₂′ is straight or branched alkyl chain of 1 to 24 carbon atoms, straight or branched chain alkenyl of 2 to 18 carbon atoms, cycloalkyl of 5 to 12 carbon atoms, phenylalkyl of 7 to 15 carbon atoms, phenyl, or said phenyl or said phenylalkyl substituted on the phenyl ring by one to three alkyl of 1 to 4 carbon atoms; or
E₂′ is said alkyl of 1 to 24 carbon atoms or said alkenyl of 2 to 18 carbon atoms substituted by one or more —OH, —OCOE₁₁, —OE₄, —NCO, —NH₂, —NHCOE₁₁, —NHE₄, —N(E₄)₂ or glycidyloxy groups, or by mixtures thereof, where E₄ is straight or branched chain alkyl of 1 to 24 carbon atoms; or said alkyl or said alkenyl interrupted by one or more —O—, —NH— or —NE₄-groups or by mixtures thereof and which can be unsubstituted or substituted by one or more —OH, —OE₄ or —NH₂ groups or mixtures thereof,
n is 1 or 2,
when n is 1,
E₅ is OE₆ or NE₇E₈, or E₅ is —PO(OE₁₂)₂, —OSi(E₁₁)₃ or —OCO-E₁₁, or straight or branched chain C₁-C₂₄alkyl which is interrupted by —O—, —S— or —NE₁₁, and which can be unsubstituted or substituted by —OH or —OCO-E₁₁, C₅-C₁₂ cycloalkyl which is unsubstituted or substituted by —OH, straight chain or branched C₂-C₁₈alkenyl which is unsubstituted or substituted by —OH, C₇-C₁₅aralkyl, —CH₂—CHOH-E₁₃ or glycidyl,
E₆ is hydrogen, straight or branched chain C₁—C₂₄alkyl which is unsubstituted or substituted by one or more OH, OE₄ or NH₂ groups, or —OE₆ is —(OCH₂CH₂)_{w}OH or —(OCH₂CH₂)_{w},OE₂₁where w is 1 to 12 and E₂₁ is alkyl of 1 to 12 carbon atoms,
E₇ and E₈ are independently hydrogen, alkyl of 1 to 18 carbon atoms, straight or branched chain C₃-C₁₈alkyl which is interrupted by —O—, —S— or —NE₁₁-, C₅-C₁₂cycloalkyl, C₆-C₁₄aryl or C₁-C₃hydroxylalkyl, or E₇ and E₈ together with the N atom are a pyrrolidine, piperidine, piperazine or morpholine ring,
E₅ is —X-(Z)ₚ-Y-E₁₅
wherein
X is —O— or —N(E₁₆)-,
Y is —O— or —N(E₁₇)-,
Z is C₂-C₁₂-alkylene, C₄-C₁₂-alkylene interrupted by one to three nitrogen atoms, oxygen atoms or a mixture thereof, or is C₃-C₁₂-alkylene, butenylene, butynylene, cyclohexylene or phenylene, each substituted by a hydroxyl group,
m is zero, 1 or 2,
p is 1, or p is also zero when X and Y are —N(E₁₆)- and —N(E₁₇)-, respectively,
E₁₅ is a group —CO—C(E₁₈)═C(H)E₁₉ or, when Y is —N(E₇)-, forms together with E₁₇ a group —CO—CH═CH—CO—, wherein E₁₈ is hydrogen or methyl, and E₁₉ is hydrogen, methyl or —CO—X-E₂₀, wherein E₂₀ is hydrogen, C₁-C₁₂-alkyl or a group of the formula 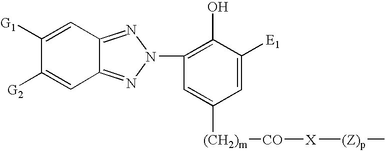
wherein the symbols E₁, G₂, X, Z, m and p have the meanings defined above, and E₁₆ and E₁₇ independently of one another are hydrogen, C₁-C₁₂-alkyl, C₃-C₁₂-alkyl interrupted by 1 to 3 oxygen atoms, or is cyclohexyl or C₇-C₁₅aralkyl, and E₁₆ together with E₁₇ in the case where Z is ethylene, also forms ethylene,
when n is 2, one of G₂ is also hydrogen,
E₅ is one of divalent radicals —O-E₉-O— or —N(E₁₁)-E₁₀-N(E₁₁)-,
E₉ is C₂-C₈alkylene, C₄-C₈alkenylene, C₄alkynylene, cyclohexylene, straight or branched chain C₄-C₁₀alkylene which is interrupted by —O— or by —CH₂—CHOH—CH₂—O-E₁₄-O—CH₂—CHOH—CH_{2—,}
E₁₀ being straight or branched chain C₂-C₁₂alkylene which may be interrupted by —O—, cyclohexylene, or 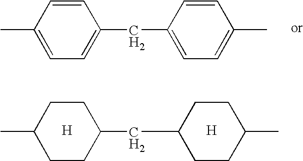
or E₁₀ and E₁₁with the two nitrogen atoms form a piperazine ring,
E₁₄ is straight or branched chain C₂-C₈alkylene, straight or branched chain C₄-C₁₀alkylene which is interrupted by —O—, cycloalkylene, arylene or 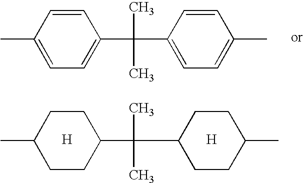
where E₇ and E₈ are independently hydrogen, alkyl of 1 to 18 carbon atoms or E₇ and E₈ together are alkylene of 4 to 6 carbon atoms, 3-oxapentamethylene, 3-iminopentamethylene or 3-methyliminopentamethylene,
E₁₁ is hydrogen, straight or branched chain C₁-C₁₈alkyl, C₅-C₁₂cycloalkyl, straight or branched chain C₂-C₁₈alkenyl, C₆-C₁₄aryl or C₇-C₁₅ aralkyl,
E₁₂ is straight or branched chain C₁-C₁₈alkyl, straight or branched chain C₃-C₁₈alkenyl, C₅-C₁₀cycloalkyl, C₆-C₁₆aryl or C₇-C₁₅aralkyl,
E₁₃ is H, straight chain or branched C₁-C₁₈alkyl which is substituted by —PO(OE₂)₂, phenyl which is unsubstituted or substituted by OH, C₇-C₁₅aralkyl or —CH₂OE₁₂,
E₃ is alkyl of 1 to 20 carbon atoms, hydroxyalkyl of 2 to 20 carbon atoms, alkyl substituted by alkoxycarbonyl of 2 to 9 carbon atoms, alkenyl of 3 to 18 carbon atoms, cycloalkyl of 5 to 12 carbon atoms, phenylalkyl of 7 to 15 carbon atoms, aryl of 6 to 10 carbon atoms or said aryl substituted by one or two alkyl of 1 to 4 carbon atoms or 1,1,2,2-tetrahydroperfluoroalkyl where the perfluoroalkyl moiety is of 6 to 16 carbon atoms, and
L is alkylene of 1 to 12 carbon atoms, alkylidene of 2 to 12 carbon atoms, benzylidene, p-xylylene, α,α,α′,α′-tetramethyl-m-xylylene or cycloalkylidene.

3. A method according to claim 1 wherein said hydroxyphenylbenzotriazole UV absorbers are of the formula 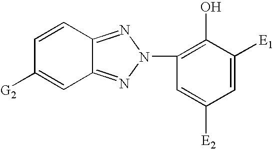
where G₂ is selected from Cl, F, —SO₂Ph, —SO₂Butyl and —CF₃; E₁ is t-butyl or α-cumyl and E₂ is selected from —CH₂CH₂OH, —CH₂CH₂CO₂H, —CO₂C₁-C₆alkyl and —CO₂(polyethylene glycol),
or the hydroxyphenylbenzotriazole UV absorbers are of the formula 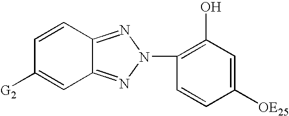
where
G₂ is selected from hydrogen, halogen, nitro, cyano, perfluoroalkyl of 1 to 12 carbon atoms, —COOG₃, —P(O)(C₆H₅)₂, —CO-G₃, —CO—NH-G₃, —CO—N(G₃)₂, —N(G₃)-CO-G₃, E₃S—, E₃SO—or E₃SO₂—; and
E₂₅ is straight or branched chain alkyl of 1 to 24 carbon atoms or straight or branched chain alkenyl of 2 to 18 carbon atoms, each substituted by one or more —OH, —OCOE₁₁, —NCO,
—NH₂, —NHCOE₁₁, —NHE₄ or glycidyloxy groups, or by mixtures thereof; or said alkyl or said alkenyl interrupted by one or more —O—, —NH— or —NE₄- groups or by mixtures thereof, where E₄ is straight or branched chain alkyl of 1 to 24 carbon atoms,
or the hydroxyphenylbenzotriazole UV absorbers are 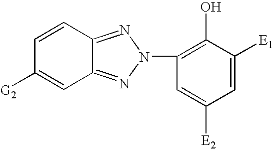
where E₁ is t-butyl or α-cumyl, E₂ is straight or branched chain alkyl of 1 to 8 carbon atoms and G₂ is CH₃OCOCH₂S— or CH₃OCOCH₂SO₂—.

4. A method according to claim 2 wherein said hydroxyphenylbenzotriazole UV absorbers are of formula (I) 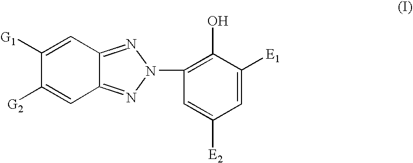
wherein
G₁ is hydrogen,
G₂ is hydrogen, cyano, chloro, fluoro, —CF₃, —COG₃, E₃SO— or E₃SO₂—,
G₃ is straight or branched chain alkyl of 1 to 24 carbon atoms, straight or branched chain alkenyl of 2 to 18 carbon atoms, cycloalkyl of 5 to 12 carbon atoms, phenylalkyl of 7 to 15 carbon atoms, phenyl, or said phenyl or said phenylalkyl substituted on the phenyl ring by 1 to 4 alkyl of 1 to 4 carbon atoms,
E₁ is phenylalkyl of 7 to 15 carbon atoms, phenyl, or said phenyl or said phenylalkyl substituted on the phenyl ring by 1 to 4 alkyl of 1 to 4 carbon atoms,
E₂ is straight or branched alkyl of 1 to 24 carbon atoms or straight or branched chain alkenyl of 2 to 18 carbon atoms, each substituted by one or more —OH, —OCOE₁₁, —NCO, —NH₂,
—NHCOE₁₁, —NHE₄ or glycidyloxy groups, or by mixtures thereof, where E₄ is straight or branched chain alkyl of 1 to 24 carbon atoms; or said alkyl or said alkenyl interrupted by one or more —O—, —NH— or —NE₄- groups or by mixtures thereof, and
E₃ is alkyl of 1 to 20 carbon atoms, hydroxyalkyl of 2 to 20 carbon atoms, alkenyl of 3 to 18 carbon atoms, cycloalkyl of 5 to 12 carbon atoms, phenylalkyl of 7 to 15 carbon atoms, aryl of 6 to 10 carbon atoms or said aryl substituted by one or two alkyl of 1 to 4 carbon atoms or 1,1,2,2-tetrahydroperfluoroalkyl where the perfluoroalkyl moiety is of 6 to 16 carbon atoms,
or is a compound of formula (I)
wherein
G₁ is hydrogen,
G₂ is chloro, fluoro, —CF₃, E₃SO— or E₃SO₂—,
E₁ is hydrogen or straight or branched alkyl of 1 to 24 carbon atoms,
E₂ is straight or branched alkyl of 1 to 24 carbon atoms or straight or branched chain alkenyl of 2 to 18 carbon atoms, each substituted by one or more —OH, —OCOE₁₁, —NCO, —NH₂,
—NHCOE₁₁, —NHE₄ or glycidyloxy groups, or by mixtures thereof, where E₄ is straight or branched chain alkyl of 1 to 24 carbon atoms; or said alkyl or said alkenyl interrupted by one or more —O—, —N— or —NE₄- groups or by mixtures thereof, and
E₃ is straight or branched chain alkyl of 1 to 7 carbon atoms.

5. A method according to claim 2 wherein said hydroxyphenylbenzotriazole UV absorbers of formula (II) are of formula (IIA) 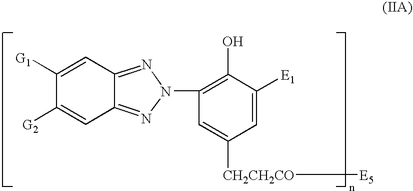
wherein
G₁ is hydrogen,
G₂ is —CF₃ or fluoro,
E₁ is hydrogen, straight or branched alkyl of 1 to 24 carbon atoms or phenylalkyl of 7 to 15 carbon atoms,
when E₁ is phenylalkyl of 7 to 15 carbon atoms, G₂ may also be hydrogen,
E₅ is —OE₈ or —NE₇E₈, or
E₅ is —X-(Z)p-Y-E₁₅
wherein
X is —O— or —N(E₁₆)-,
Y is —O— or —N(E₁₇)-,
Z is C₂-C₁₂-alkylene, C₄-C₁₂-alkylene interrupted by one to three nitrogen atoms, oxygen atoms or a mixture thereof, or is C₃-C₁₂-alkylene, butenylene, butynylene, cyclohexylene or phenylene, each substituted by a hydroxyl group,
m is 0, 1, 2 or 3,
p is 1, or p is also zero when X and Y are —N(E₁₆)- and —N(E₁₇)-, respectively, E₁₅ is a group —CO—C(E₁₈)═C(H)E₁₉ or, when Y is —N(E₁₇)-, forms together with E₁₇ a group —CO—CH═CH—CO—, wherein E₁₈ is hydrogen or methyl, and E₁₉ is hydrogen, methyl or —CO—X-E₂₀, wherein E₂₀ is hydrogen, C₁-C₁₂-alkyl or a group of the formula

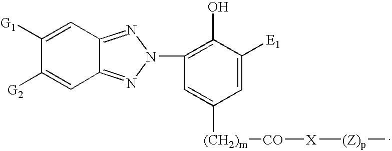

6. A method according to claim 2 wherein said hydroxyphenylbenzotriazole UV absorbers of formula (III) are of the formula (IIIA) 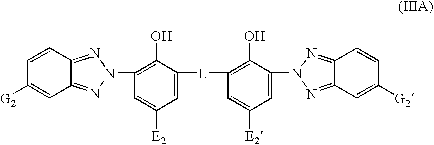
wherein
G₂ and G₂′ are independently hydrogen or —CF₃, where at least one of G₂ and G₂′ is —CF₃,
E₂ is straight or branched chain alkyl of 1 to 24 carbon atoms or straight or branched chain alkenyl of 2 to 18 carbon atoms, each substituted by one or more —OH, —OCOE₁₁, —NCO,
—NH₂, —NHCOE₁₁, —NHE₄ or glycidyloxy groups, or by mixtures thereof; or said alkyl or said alkenyl interrupted by one or more —O—, —NH— or —NE₄- groups or by mixtures thereof, where E₄ is straight or branched chain alkyl of 1 to 24 carbon atoms,
E₂′ is straight or branched alkyl chain of 1 to 24 carbon atoms, straight or branched chain alkenyl of 2 to 18 carbon atoms, cycloalkyl of 5 to 12 carbon atoms, phenylalkyl of 7 to 15 carbon atoms, phenyl, or said phenyl or said phenylalkyl substituted on the phenyl ring by 1 to 3 alkyl of 1 to 4 carbon atoms; or
E₂′ is straight or branched chain alkyl of 1 to 24 carbon atoms or straight or branched chain alkenyl of 2 to 18 carbon atoms substituted by one or more —OH, —OCOE₁₁, —NCO, —NH₂,
—NHCOE₁₁, —NHE₄ or glycidyloxy groups, or by mixtures thereof; or said alkyl or said alkenyl interrupted by one or more —O—, —NH— or —NE₄- groups or by mixtures thereof, where E₄ is straight or branched chain alkyl of 1 to 24 carbon atoms; and
L is alkylene of 1 to 12 carbon atoms, alkylidene of 2 to 12 carbon atoms, benzylidene, p-xylylene, α,α,α′,α′-tetramethyl-m-xylylene or cycloalkylidene.

7. A method according to claim 2 wherein said hydroxyphenylbenzotriazole UV absorbers are of formula (I) 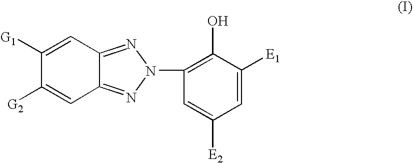
wherein
G₁ is hydrogen,
G₂ is —CF₃,
E₁ is phenylalkyl of 7 to 15 carbon atoms, phenyl, or said phenyl or said phenylalkyl substituted on the phenyl ring by 1 to 4 alkyl of 1 to 4 carbon atoms,
E₂ is straight or branched chain alkyl of 1 to 24 carbon atoms or straight or branched chain alkenyl of 2 to 18 carbon atoms, each substituted by one or more —OH, —OCOE₁₁, —NH₂, —NHCOE₁₁ or glycidyloxy groups, or by mixtures thereof, or said alkyl or said alkenyl interrupted by one or more —O—,
or is a compound of formula (I) wherein,
G₁ is hydrogen,
G₂ is —CF₃,
E₁ is hydrogen, straight or branched alkyl of 4 to 24 carbon atoms or phenylalkyl of 7 to 15 carbon atoms, and
E₂ is straight or branched chain alkyl of 1 to 24 carbon atoms or straight or branched chain alkenyl of 2 to 18 carbon atoms, each substituted by one or more —OH, —OCOE₁₁, —NH₂, —NHCOE₁₁ or glycidyloxy groups, or by mixtures thereof, or said alkyl or said alkenyl interrupted by one or more —O—.

8. A method according to claim 2 wherein said hydroxyphenylbenzotriazole UV absorbers of formula (II) are of formula (IIA) 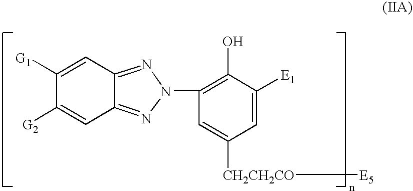
wherein
G₁ is hydrogen,
G₂ is —CF₃,
E₁ is hydrogen, straight or branched alkyl of 4 to 24 carbon atoms or phenylalkyl of 7 to 15 carbon atoms,
E₅ is —OE₆ or —NE₇E₈ where
E₆ is hydrogen, straight or branched chain C₁-C₂₄alkyl which is unsubstituted or substituted by one or more OH groups, or —OE₆ is —(OCH₂CH₂)_{w}OH or —(OCH₂CH₂)_{w}OE₂₁where w is 1 to 12 and E₂₁ is alkyl of 1 to 12 carbon atoms, and
E₇ and E₈ are independently hydrogen, alkyl of 1 to 18 carbon atoms, straight or branched chain C₃-C₁₈alkyl which is interrupted by —O—, —S— or —NE,-, C₅-C₁₂cycloalkyl, C₆-C₁₄aryl or C₁-C₃hydroxylalkyl, or E₇ and E₈ together with the N atom are a pyrrolidine, piperidine, piperazine or morpholine ring.

9. A method according to claim 2 wherein said hydroxyphenylbenzotriazole UV absorbers of formula (III) are of formula (IIIA) 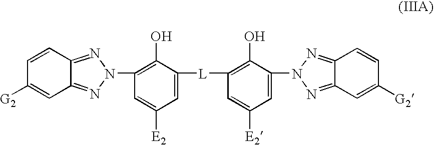
wherein
G₂ and G₂′ are independently hydrogen or —CF₃, where at least one of G₂ and G₂′ is —CF₃,
E₂ is straight or branched chain alkyl of 1 to 24 carbon atoms or straight or branched chain alkenyl of 2 to 18 carbon atoms, each substituted by one or more —OH, —OCOE₁₁, —NH₂, —NHCOE₁₁, or glycidyloxy groups, or by mixtures thereof, or said alkyl or said alkenyl interrupted by one or more —O—,
E₂′ is straight or branched alkyl chain of 1 to 24 carbon atoms, straight or branched chain alkenyl of 2 to 18 carbon atoms, cycloalkyl of 5 to 12 carbon atoms, phenylalkyl of 7 to 15 carbon atoms, phenyl, or said phenyl or said phenylalkyl substituted on the phenyl ring by 1 to 3 alkyl of 1 to 4 carbon atoms; or
E₂′ is straight or branched chain alkyl of 1 to 24 carbon atoms or straight or branched chain alkenyl of 2 to 18 carbon atoms substituted by one or more —OH, —OCOE₁₁, —NH₂, —NHCOE₁₁ or glycidyloxy groups, or by mixtures thereof, or said alkyl or said alkenyl interrupted by one or more —O—,
L is methylene.

10. A method according to claim 2 wherein said hydroxyphenylbenzotriazole UV absorbers are selected from the group consisting of
(a) 3-(5-trifluoromethyl-2H-benzotriazol-2-yl)-5-tert-butyl-4-hydroxyhydrocinnamic acid;
(b) methyl 3-(5-trifluoromethyl-2H-benzotriazol-2-yl)-5-tert-butyl-4-hydroxyhydrocinnamate;
(c) isooctyl 3-(5-trifluoromethyl-2H-benzotriazol-2-yl)-5-tert-butyl-4-hydroxyhydrocinnamate;
(d) 5-trifluoromethyl-2-[2-hydroxy-5-(3-hydroxypropyl)phenyl]-2H-benzotriazole;
(e) 5-trifluoromethyl-2-[2-hydroxy-3-α-cumyl-5-(2-hydroxyethyl)phenyl]-2H-benzotriazole;
(f) 5trifluoromethyl-2-[2-hydroxy-3-α-cumyl-5-(3-hydroxypropyl)phenyl]-2H-benzotriazole;
(g) 5-trifluoromethyl-2-[2-hydroxy-3-tert-butyl-5-(3-hydroxypropyl)phenyl)-2H-benzotriazole;
(h) 5-trifluoromethyl-2-[2-hydroxy-3-tert-butyl-5-(2-hydroxyethyl)phenyl]-2H-benzotriazole;
(i) 5-trifluoromethyl-2-[2-hydroxy-5-(2-hydroxyethyl)phenyl]-2H-benzotriazole;
(j) isooctyl 3-(5-chloro-2H-benzotriazol-2-yl)-5-tert-butyl-4-hydroxyhydrocinnamate;
(k) isooctyl 3-(5-phenylsulfonyl-2H-benzotriazol-2-yl)-5-tert-butyl-4-hydroxyhydrocinnamate;
(l) methyl 3-(5-phenylsulfonyl-2H-benzotriazol-2-yl)-5-tert-butyl-4-hydroxyhydrocinnamate;
(m) 3-(5-phenylsulfonyl-2H-benzotriazol-2-yl)-5-tert-butyl-4hydroxyhydrocinnamic acid;
(n) 3-(5-trifluoromethyl-2H-benzotriazol-2-yl)-α-cumyl-4-hydroxyhydrocinnamic acid;
(o) isooctyl 3-(5-chloro-2H-benzotriazol-2-yl)-5-tert-butyl-4-hydroxyhydrocinnamate;
(p) methyl 3-(5-chloro-2H-benzotriazol-2-yl)-5-tert-butyl-4-hydroxyhydrocinnamate;
(q) 3-(5-chloro-2H-benzotriazol-2-yl)-5-tert-butyl-4-hydroxyhydrocinnamic acid;
(r) methyl 3-(5-fluoro-2H-benzotriazol-2-yl)-5-tert-butyl-4-hydroxyhydrocinnamate;
(s) 5-trifluoromethyl-2-[2-hydroxy-3-tert-butyl-4-(2-hydroxyethoxy)phenyl]-2H-benzotriazole;
(t) 5-chloro-2-[2-hydroxy-3-tert-butyl-4-(2-hydroxyethoxy)phenyl]-2H-benzotriazole and
(u) 5-(methoxycarbonylmethylsulfonyl)-3,5-di-tert-butyl-2-hydroxyphenyl-2H-benzotriazole.

11. A method according to claim 1 in which component (a) is a polyester or a polyamide.

12. A method according to claim 1 wherein the container or film comprises at least one hydroxyphenylbenzotriazole moiety and at least one further moiety selected from the group consisting of the s-triazine moieties, or which comprises a mixture of two or more different hydroxyphenylbenzotriazole moieties.

13. A method according to claim 1 in which said contents are selected from the group consisting of fruit juices, soft drinks, beer, wines, meats, vegetables, food products, dairy products, personal care products, cosmetics, shampoos, vitamins, pharmaceuticals, inks, dyes and pigments.

14. A method according to claim 1 wherein the plastic container or film is rigid or flexible and is mono- or multi-layered,
wherein each layer is comprised of one or more polymers selected from the group consisting of polyesters, polyolefins, polyolefin copolymers, ethylene-vinyl acetate, polystyrene, poly(vinyl chloride), poly(vinylidene chloride), polyamides, cellulosics, polycarbonates, ethylene-vinyl alcohol, poly(vinyl alcohol), poly(vinyl alcohol) copolymers, styrene-acrylonitrile, ionomers, partially hydrolyzed poly(vinyl acetate), poly(ethylene-co-vinyl alcohol), polyvinylidene chloride, polyurethanes, PVDC and epoxies.

15. A method according to claim 14 wherein the UV absorbing moieties of component (b) are incorporated into a coating applied to the outer surface of the container or film.

16. A method according to claim 1 in which the UV absorbing moieties of component (b) are present from about 0.1 to about 20% by weight based on the weight of the plastic container or film.

17. A method according to claim 1 wherein the plastic container or film additionally comprises at least one coadditive selected from the group consisting of antioxidants, other UV absorbers, hindered amines, phosphites or phosphonites, hydroxylamines, nitrones, benzofuran-2-ones, thiosynergists, polyamide stabilizers, metal stearates, nucleating agents, fillers, reinforcing agents, lubricants, emulsifiers, dyes, pigments, optical brighteners, flame retardants, antistatic agents and blowing agents.

18. A polymer masterbatch comprising
(a) a polymer component able to undergo a condensation reaction and
(b) an effective stabilizing amount of one or more UV absorbing moieties,
wherein said moieties are permanently and covalently bonded to the polymer component and are derived, via condensation, from UV absorbers selected from the group consisting of the durable hydroxyphenylbenzotriazole absorbers, and
wherein component (b) is about 2.5% to about 95% by weight based on the weight of the polymer component (a).

19. Use of a hydroxyphenylbenzotriazole UV absorbers of formula (I), (II) or (III) according to claim 2 for content protection in a clear or lightly colored plastic container or film,
which container or film comprises
(a) a polymer component able to undergo a condensation reaction and
(b) an effective stabilizing amount of one or more UV absorbing moieties,
wherein said moieties are permanently and covalently bonded to the polymer component.
